(19) United States
(12) Patent Application Publication
(10) Pub. No.: US 2006/0061847 A1
(43) Pub. Date: Mar. 23, 2006

(54) Light deflector, method of manufacturing the same, optical scanning device, and image-forming apparatus

(76) Inventor: Yukio Itami, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/219,767

(22) Filed: Sep. 7, 2005

(30) Foreign Application Priority Data
Sep. 8, 2004 (JP) 2004-261591
Oct. 13, 2004 (JP) 2004-299239

(51) Int. Cl. G02B 26/08

(52) U.S. Cl. 359/205

(57) ABSTRACT

A light deflector is disclosed that includes a rotary body supported by a dynamic pressure bearing and rotated by a motor. The rotary body includes a sleeve having a dynamic pressure bearing surface formed on the interior circumferential surface thereof; a flange fixed to the exterior circumferential surface of the sleeve; a polygon mirror press-fitted and fixed to the flange; and a permanent magnet for driving. A substantially cup-like hollow is formed inside the polygon mirror. The polygon mirror is fixed to the flange with the pressure bearing surface formed on the sleeve overlapping at least part of a reflection surface formed on the polygon mirror at a position in a direction of a rotation axis.

### BACKGROUND OF THE INVENTION

1. Field of the Invention

The present invention relates to a light deflector employed in electrophotographic copiers, printers, facsimile machines, and machines having their respective functions; an optical scanning device using the light deflector; and an image-forming apparatus using the optical scanning device.

2. Description of the Related Art

In recent years, with increasing printing speed and increasing pixel density, electrophotographic recorders using a laser writer, such as digital copiers and laser printers, have been required to have a light deflector that rotates at speeds higher than or equal to 20,000 rpm (revolutions per minute). In addition, in such recording apparatuses, a light deflector using a dynamic pressure bearing in the support part of a rotary body has been put to practical use in order to satisfy the quality requirements of long useful service life, high durability, and low noise.

For example, Japanese Laid-Open Patent Application No. 7-190047 discloses such a light deflector. In the light deflector disclosed therein, a rotary polygon mirror serving as a deflection reflection surface is formed integrally with a high-speed rotary body positioned outside a ceramic fixed shaft and forming a gas dynamic pressure bearing together with the fixed shaft. The high-speed rotary body includes a ceramic sleeve radially uniform in thickness and a metal outer cylindrical member fixed to the exterior surface of the ceramic sleeve by shrink fitting. The coefficient of thermal expansion of the outer cylindrical member is greater than that of the ceramic sleeve. In this light deflector, the bore of the ceramic sleeve is processed into a predetermined hourglass shape after the outer cylindrical member is fixed thereto by shrink fitting. The hourglass shape of the bore of the ceramic sleeve is determined so that the gap between the ceramic fixed shaft and the ceramic sleeve becomes uniform in accordance with a radial centrifugal stress caused to act by speed of rotation employed by the high-speed rotary body and a compressive stress due to shrink fitting, which is relaxed by thermal expansion due to friction.

However, in this conventional case, when the rotary polygon mirror with mirror finishing is shrink-fitted, its reflection surface is distorted by a compressive stress at the time of shrink fitting, thus degrading the flatness of the reflection surface. This prevents the reflection surface from maintaining high accuracy, thus resulting in a problem in that good image output cannot be obtained.

Even in the case of processing the reflection surface of the polygon mirror after shrink fitting, an increase in the temperature of the rotary body due to high-speed rotation removes a compressive stress due to shrink fitting since the ceramic sleeve has a smaller coefficient of linear expansion than the metal outer cylindrical member. This distorts the deflection reflection surface of the polygon mirror, thus degrading its flatness. This prevents the reflection surface from maintaining high accuracy, thus causing a problem in that good image output cannot be obtained.

The method of fixing a rotary polygon mirror to a rotary body is not limited to the one shown in the above-described conventional case. For instance, the rotary polygon mirror may be fixed to the rotary body with screws, through leaf springs, by press fitting, or by bonding. In any of these methods, a stress due to mounting (fixing) is generated, thus adversely affecting the reflection surface. Further, since two components are superposed one on the other in configuration, the reflection surface of the polygon mirror has greater angular variations (face tangle error). Further, a change in weight balance throws the rotary body off balance, so that vibration is likely to increase. Vibration generated by a light deflector vibrates the surroundings of the light deflector, thus causing noise and image degradation. In particular, with a high-speed rotation of 20,000 rpm or over, noise level is likely to increase.

Japanese Laid-Open Patent Application No. 2000-206439 proposes the following deflector with the view of solving the above-described problems. In the deflector, a cylindrical projection projecting in an axial direction is formed on a metal outer member shrink-fitted or press-fitted to a ceramic sleeve supported by a dynamic pressure bearing. A boss-like projection projecting in an axial direction is formed on a polygon mirror inside its reflection surface in a radial direction. The polygon mirror has substantially the same coefficient of thermal expansion as the metal outer member. The exterior circumferential surface of the boss-like projection is press-fitted and fixed to the interior cylindrical surface of the cylindrical projection. According to this configuration, even if distortion occurs in the press-fitted part of the sleeve and the metal outer member having different coefficients of thermal expansion at the time of a temperature increase, the effect of the distortion acting on the reflection surface of the polygon mirror is reduced to a negligible level, thereby keeping the function of deflecting a light beam highly accurate.

However, in this conventional case, the axially projecting boss-like projection is provided on the polygon mirror, and is fixed to the axially projecting cylindrical projection of the metal outer member. Accordingly, the center of gravity of the rotary body is biased to the polygon mirror side, and the unbalance of the rotary body cannot be reduced sufficiently by correcting the balance of the rotary body, thus resulting in great vibration due to unbalance. Further, surface finishing is performed on the reflection surface of the polygon mirror with the polygon mirror being fixed with a reference surface for mirror finishing provided thereon. Accordingly, the angle of the reflection surface to the rotation center axis of the dynamic pressure bearing varies greatly.

### SUMMARY OF THE INVENTION

Accordingly, it is a general object of the present invention to provide a light deflector in which the above-described disadvantages are eliminated.

A more specific object of the present invention is to provide a light deflector that can maintain a highly accurate deflection reflection surface; reduce variations in the angle (face tangle error) of the deflection reflection surface; obtain good image output; and correct the balance of a rotary body with high accuracy, thereby reducing vibration and noise, by placing the center of gravity of the rotary body at or around the center of the dynamic pressure bearing.

Another more specific object of the present invention is to provide a method of manufacturing such a light deflector, a highly accurate low-vibration and low-noise optical scanning device using such a light deflector, and an image-forming apparatus of high image quality and low noise using such an optical scanning device.

One or more of the above objects of the present invention may be achieved by a light deflector including a rotary body supported by a dynamic pressure bearing and rotated by a motor, the rotary body including: a sleeve having a dynamic pressure bearing surface formed on an interior circumferential surface thereof; a flange fixed to an exterior circumferential surface of the sleeve; a polygon mirror press-fitted and fixed to the flange; and a permanent magnet for driving, wherein a substantially cup-like hollow is formed inside the polygon mirror, and the polygon mirror is fixed to the flange with the pressure bearing surface formed on the sleeve overlapping at least part of a reflection surface formed on the polygon mirror at a position in a direction of a rotation axis.

According to one embodiment of the present invention, it is possible to provide a light deflector for high-speed rotation in which: the deformation of a mirror reflection surface due to a change in temperature is minimized; and it is possible to correct the balance of a rotary body with accuracy by disposing the center of gravity of the rotary body in the substantial center of a dynamic pressure bearing, so that a change in the balance (unbalance) of the rotary body due to temperature is controlled so as to reduce vibration.

One or more of the above objects of the present invention may also be achieved by a light deflector including a rotary body supported by a dynamic pressure bearing and rotated by a motor, the rotary body including: a sleeve having a dynamic pressure bearing surface thereon; a flange fixed to the sleeve; a polygon mirror press-fitted and coupled to the flange; and a permanent magnet for driving, wherein a cup-like hollow is formed inside the polygon mirror; the polygon mirror is fixed to the flange with at least part of a reflection surface formed on the polygon mirror overlapping the pressure bearing surface formed on the sleeve at a position in a direction of a rotation axis; and an elastic member is provided between the flange and the polygon mirror.

According to one embodiment of the present invention, in a light deflector, when a polygon mirror is press-fitted to a flange, the polygon mirror is elastically fixed to the flange through an elastic member provided between the polygon mirror and the flange. This prevents displacement of the polygon mirror due to a change in temperature or vibrator impact. Accordingly, a change over time in the contact with the flange is reduced, so that a change over time in the accuracy of the deflection reflection surface of the polygon mirror is reduced. Further, a decrease in the accuracy of the deflection reflection surface of the polygon mirror due to unevenness of the contact surfaces of the flange and the polygon mirror is prevented. Thus, a light deflector that can withstand high-speed rotation is provided.

The above-described effects may also be produced without adding a special component by a light deflector including a rotary body supported by a dynamic pressure bearing and rotated by a motor, the rotary body including: a sleeve having a dynamic pressure bearing surface thereon; a flange fixed to the sleeve; a polygon mirror press-fitted and coupled to the flange; and a permanent magnet for driving, wherein a cup-like hollow is formed inside the polygon mirror; the polygon mirror is fixed to the flange with at least part of a reflection surface formed on the polygon mirror overlapping the pressure bearing surface formed on the sleeve at a position in a direction of a rotation axis; and the flange has an elastic deformation part formed thereon, the elastic deformation part being easily deformable in an axial direction of the flange and brought into contact with the flange by pressure.

One or more of the above objects of the present invention may also be achieved by a method of manufacturing a light deflector according to the present invention, wherein the reflection surface of the polygon mirror is formed by mirror finishing after the sleeve and the flange are integrated with the polygon mirror.

One or more of the above objects of the present invention may also be achieved by an optical scanning device including a semiconductor laser and an optical system including a light deflector according to the present invention, wherein one or more light beams emitted from the semiconductor laser are guided through the optical system onto a scanning surface to be scanned so as to be focused into one or more light beam spots thereon, the one or more light beams being deflected by the light deflector so as to scan the scanning surface with one or more scanning lines (light beam spots).

According to one embodiment of the present invention, it is possible to provide an optical scanning device in which: noise resulting from the vibration of a light deflector is reduced; the reflection surface of the light deflector is maintained with high accuracy; and the shape of a scanning light beam is constant and stable.

One or more of the above objects of the present invention may also be achieved by an image-forming apparatus including: an optical scanning device including a semiconductor laser and an optical system including a light deflector according to the present invention; and a photosensitive body having a photosensitive surface, wherein one or more light beams emitted from the semiconductor laser are guided through the optical system onto the photosensitive surface so as to be focused into one or more light beam spots thereon, the one or more light beams being deflected by the light deflector so as to scan the photosensitive surface with one or more scanning lines (light beam spots), thereby forming a latent image on the photosensitive surface; and the latent image is made visible so that an image is obtained.

According to one embodiment of the present invention, it is possible to provide an image-forming apparatus in which: noise resulting from the vibration of a light deflector is reduced; the reflection surface of the light deflector is maintained with high accuracy; and the shape of a scanning light beam is constant and stable.

### BRIEF DESCRIPTION OF THE DRAWINGS

Other objects, features and advantages of the present invention will become more apparent from the following detailed description when read in conjunction with the accompanying drawings, in which:

FIG. 1 is a cross-sectional view of a light deflector using a dynamic pressure air bearing according to a first embodiment of the present invention;

FIG. 2 is a cross-sectional view of a rotary body of the light deflector of FIG. 1 according to the first embodiment of the present invention;

FIG. 3 is an enlarged view of a mirror press fitting part of the light deflector of FIG. 1 according to the first embodiment of the present invention;

FIG. 4 is an exploded perspective view of the light deflector of FIG. 1 according to the first embodiment of the present invention;

FIG. 5 is a cross-sectional view of part of the light deflector of FIG. 1 for illustrating a procedure for processing a reference surface for mirror finishing according to the first embodiment of the present invention;

FIG. 6 is a cross-sectional view of a light deflector according to a second embodiment of the present invention;

FIG. 7 is a cross-sectional view of a light deflector according to a third embodiment of the present invention;

FIG. 8 is a perspective view of an optical scanning device according to a fourth embodiment of the present invention;

FIG. 9 is a perspective view of an optical scanning device according to a fifth embodiment of the present invention;

FIG. 10 is a schematic diagram showing a tandem full-color laser printer according to a sixth embodiment of the present invention as an image-forming apparatus including a light deflector according to the present invention;

FIG. 11 is a cross-sectional view of a light deflector using a dynamic pressure air bearing according to a seventh embodiment of the present invention;

FIG. 12 is a cross-sectional view of a rotary body of the light deflector of FIG. 11 according to the seventh embodiment of the present invention;

FIG. 13 is an enlarged view of a polygon mirror press fitting part of the light deflector of FIG. 11 according to the seventh embodiment of the present invention;

FIG. 14 is a cross-sectional view of part of the light deflector of FIG. 11 for illustrating a procedure for processing a reference surface for mirror finishing according to the seventh embodiment of the present invention;

FIG. 15 is an exploded perspective view of the light deflector of FIG. 11 according to the seventh embodiment of the present invention;

FIG. 16 is a cross-sectional view of a rotary body of a light deflector according to an eighth embodiment of the present invention;

FIG. 17 is a cross-sectional view of a variation of the rotary body of the light deflector according to the eighth embodiment of the present invention;

FIG. 18 is a cross-sectional view of a rotary body of a light deflector according to a ninth embodiment of the present invention;

FIG. 19 is a perspective view of an optical scanning device according to a tenth embodiment of the present invention;

FIG. 20 is a perspective view of a multi-beam optical scanning device according to an 11^{th} embodiment of the present invention; and

FIG. 21 is a schematic diagram showing a tandem full-color laser printer according to a 12^{th} embodiment of the present invention as an image-forming apparatus including a light deflector according to the present invention.

### DETAILED DESCRIPTION OF THE PREFERRED EMBODIMENTS

A description is given, with reference to the accompanying drawings, of embodiments of the present invention.

### First Embodiment

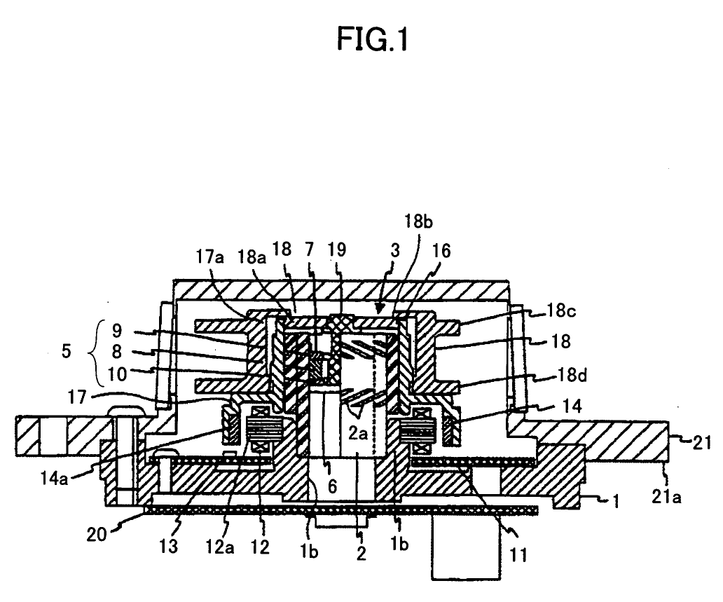

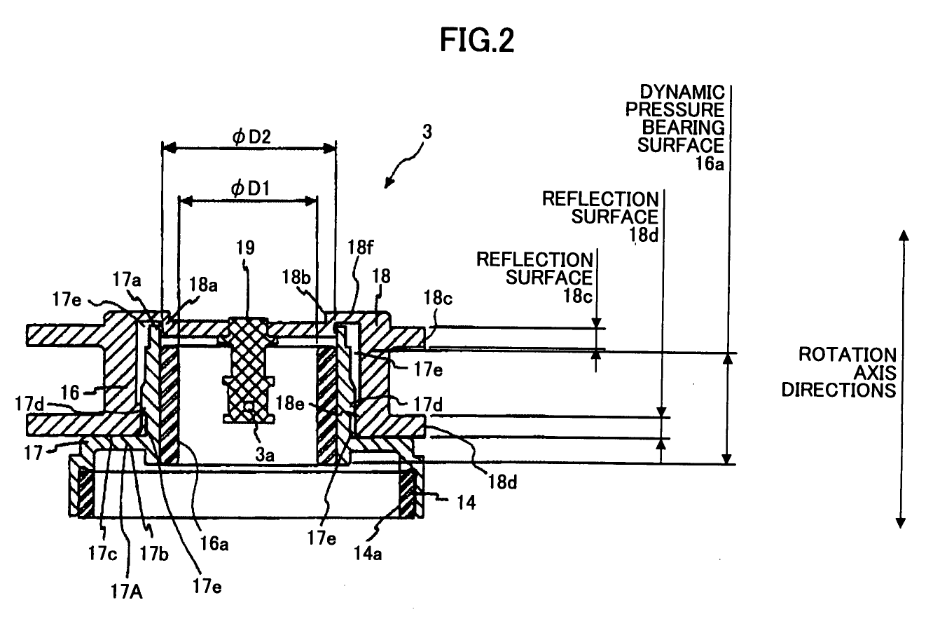

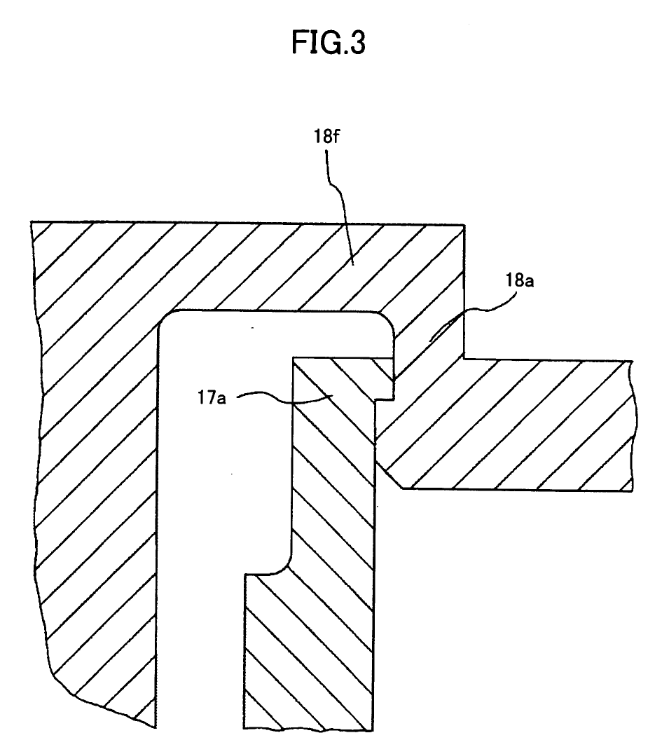

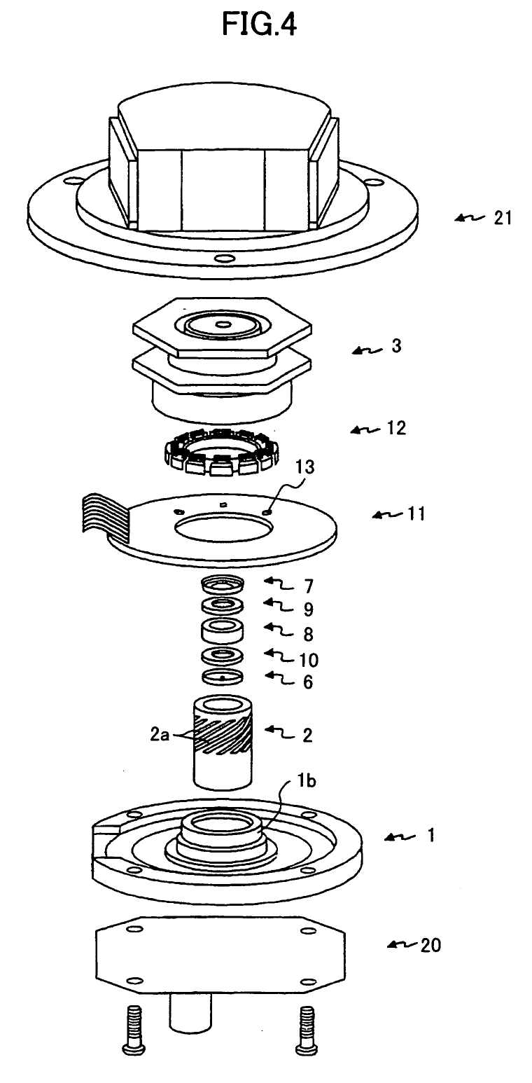

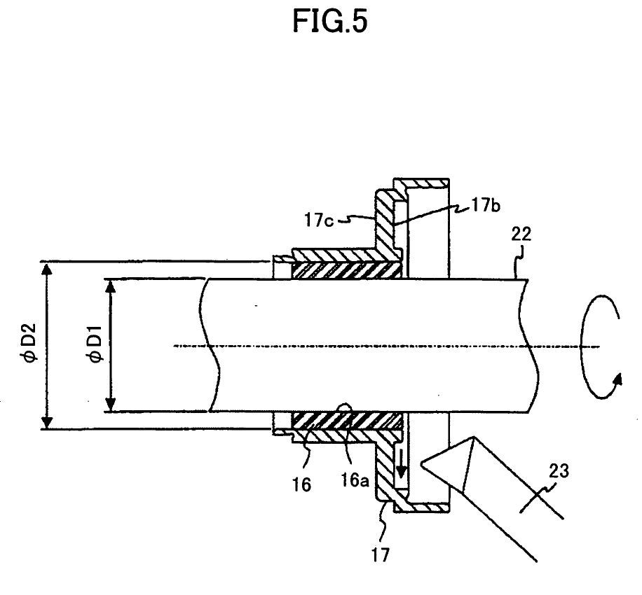

A description is given, with reference to FIGS. 1 through 5, of a configuration and an operation of a light deflector using a dynamic pressure air bearing according to a first embodiment of the present invention. The dynamic pressure air bearing may also employ gas other than air as lubricating fluid. FIG. 1 is a cross-sectional view of the light deflector using a dynamic pressure air bearing according to the first embodiment. FIG. 2 is a cross-sectional view of a rotary body of the light deflector of FIG. 1. FIG. 3 is an enlarged view of a mirror press fitting part of the light deflector of FIG. 1. FIG. 4 is an exploded perspective view of the light deflector of FIG. 1. FIG. 5 is a cross-sectional view of part of the light deflector of FIG. 1 for illustrating a procedure for processing a reference surface for mirror finishing.

Referring to FIGS. 1 through 5, a reference surface 21a for attachment to an optics housing is formed on the lower surface of a cover case 21 of the light deflector. A housing 1 is fixed to the reference surface 21a of the cover case 21. A through hole-like bearing attachment part 1b is formed in the center of the upper surface of the housing 1. A fixed shaft 2 forming a dynamic pressure bearing is fitted into and fixed to the bearing attachment part 1b.

Multiple oblique grooves 2a for forming the dynamic pressure bearing are formed on the surface of the cylindrical fixed shaft 2. When a rotary body 3 starts rotating, the air pressure of a bearing gap formed between the fixed shaft 2 and a sleeve 16 provided around the upper part of the fixed shaft 2 increases so that the rotary body 3 is supported in a radial direction with respect to the fixed shaft 2 without contact therewith.

A fixation part 5 of an attraction-type magnetic bearing is fixed to the fixed shaft 2 in its internal hollow part. A cap 6 and a stopper 7 are press-fitted and fixed to the internal cylindrical part (hollow part) of the fixed shaft 2 so as to hold and fix the fixation part 5 of the attraction-type magnetic bearing between the cap 6 and the stopper 7 in the axial directions of the fixed shaft 2.

At least one fine hole of approximately 0.2-0.5 mm in diameter for attenuating vertical vibration by using viscous resistance at the time of air passage is formed in the center part of the cap 6. A non-magnetic material such as stainless steel is used as a material for both the cap 6 and the stopper 7.

The fixation part 5 of the attraction-type magnetic bearing includes an annular permanent magnet 8 magnetized with two polarities in the directions of a rotation axis, a first fixed yoke plate 9 of a ferromagnetic material with a central circular hole having a diameter smaller than the inside diameter of the annular permanent magnet 8, and a second fixed yoke plate 10 of a ferromagnetic material with a central circular hole having a diameter smaller than the inside diameter of the annular permanent magnet 8.

The annular permanent magnet 8 is sandwiched between the first fixed yoke plate 9 and the second fixed yoke plate 10 in the axial directions. The first fixed yoke plate 9 and the second fixed yoke plate 10 are disposed and fixed so that the central circle of the first fixed yoke plate 9 and the central circle of the second fixed yoke plate 10 are concentric with the rotation center axis.

A permanent magnet based on a rare earth material is mainly used for the annular permanent magnet 8. A steel-based plate is used as a material for the fixed yoke plates 9 and 10.

A printed board 11 in which a hole is formed in its center part is disposed on the upper surface of the housing 1. A stator 12 is fitted and fixed to the bearing attachment part 1b of the housing 1 on its outer side.

A conductive material such as an aluminum alloy is used as a material for the housing 1. Accordingly, eddy current flows in the housing 1 because of an alternating field due to the rotation of a rotor magnet 14. The printed board 11 may be formed of an iron substrate in order to prevent this eddy current from increasing motor loss.

Hall elements 13, which are position detecting elements for switching current to a winding coil (motor winding) 12a, are mounted on the printed board 11.

A motor part includes the rotor magnet 14 attached to the rotary body 3, the stator 12 around which the winding coil 12a is wound, the printed board 11 to which the winding coil 12a is connected, and the Hall elements 13 mounted on the printed board 11. The stator 12 is a lamination of silicon steel plates in order to prevent eddy current from flowing therein to increase core loss.

Referring to FIG. 2, the rotary body 3 includes the sleeve 16, a flange 17 fixed to the outside of the sleeve 16, a polygon mirror 18 fixed to the flange 17 so as to cover the upper end to the exterior surface of its upper cylindrical part, a rotary part 19 of the magnetic bearing fixed to the center part of the polygon mirror 18 so as to project downward, and the rotor magnet 14 fixed to the interior surface of a larger-diameter lower cylindrical part at the lower part of the flange 17.

The sleeve 16 is formed of ceramic, and the flange 17 is formed of an aluminum alloy. The sleeve 16 and the flange 17 are fixed by shrink fitting. The rotor magnet 14 for a motor is bonded or press-fitted to the lower cylindrical part of the flange 17.

The rotor magnet 14 may be formed of separate permanent magnets provided in a circumferential direction. In this case, however, the rotor magnet 14 is shaped like a ring so as to facilitate bonding or press fitting. A plastic magnet having substantially the same coefficient of linear expansion as the flange 17 may be used as a material for the rotor magnet 14, and be fixed by press fitting. This makes it possible to reduce a change in the unbalance vibration of the rotary body 3 due to a change in temperature. Accordingly, this is more suitable for a motor for high-speed rotation.

A press fitting inside diameter part (or simply a press fitting part) 17a with a step is formed at the upper end of the flange 17. A press fitting outside diameter part (or simply a press fitting part) 18a with a step is formed on the polygon mirror 18, and is press-fitted into and fixed to the press fitting inside diameter part 17a of the flange 17.

The press fitting outside diameter part 18a of the polygon mirror 18 is formed to be slightly greater in diameter than the press fitting inside diameter part 17a of the flange 17. Both the flange 17 and the polygon mirror 18 are formed of an aluminum alloy, but employ different types of alloys although the difference is less than or equal to several percent in the coefficient of linear expansion.

A pure aluminum-based alloy with a high aluminum content is used for the polygon mirror 18 in order to form a highly reflective mirror surface. The coefficient of linear expansion of the material of the polygon mirror 18 is approximately 24.6×10⁻⁶/° C. On the other hand, a structural material aluminum alloy is employed for the flange 17. The coefficient of linear expansion of the material of the flange 17 is approximately 23.8×10⁻⁶/° C. Thus, the flange 17 is smaller in the coefficient of linear expansion than the polygon mirror 18 by approximately 3%.

Referring to FIG. 2, the press fitting inside diameter part 17a and the press fitting outside diameter part 18a are through holes having a diameter D2 greater than the diameter D1 of the dynamic pressure bearing. A reference surface for mirror finishing (mirror finishing reference surface) 17b perpendicular to a dynamic pressure bearing surface 16a of the sleeve 16 is formed on the flange 17. That is, the mirror finishing reference surface 17b defines the lower surface of a projecting part 17A of the lower cylindrical part of the flange 17. Further, a mirror contact surface 17c is positioned on the upper surface of the projecting part 17A. Thus, the mirror finishing reference surface 17b is formed on the other (opposite) side of the mirror contact surface 17c from the polygon mirror 18.

The exterior circumferential surface of the flange 17 projects slightly to form a guide part for press fitting (press fitting guide part) 17d (FIGS. 2 and 4) slightly above the mirror contact surface 17c. Above the mirror contact surface 17c of the flange 17, a space 17e (FIG. 2) is formed around the exterior circumferential surface of the flange 17 so as to avoid contact with the inside of the polygon mirror 18.

Two deflection reflection surfaces 18c and 18d are formed integrally with the polygon mirror 18 on its exterior circumferential surface in tiers in the axial directions. A substantially cup-like hollow is formed inside the polygon mirror 18. The polygon mirror 18 is fixed with the dynamic pressure bearing surface 16a (FIG. 2) formed on the sleeve 16 overlapping part of the deflection reflection surfaces 18c and 18d formed on the polygon mirror 18 at a position in the directions of the rotation axis. The rotary part 19 of the attraction-type magnetic bearing is fixed to the hole in the center of the upper surface of the polygon mirror 18 by press fitting.

The rotary part 19 of the attraction-type magnetic bearing has an exterior cylindrical surface. The rotary part 19 is disposed so that a magnetic gap is formed between the exterior cylindrical surface and the central circular holes of the first fixed yoke plate 9 and the second fixed yoke plate 10 as shown in FIG. 1 and that the exterior cylindrical surface is concentric with the rotation center axis. A permanent magnet or a steel-based ferromagnetic material is employed as a material for the rotary part 19 of the attraction-type magnetic bearing.

A guide part for press fitting (press fitting guide part) 18e (FIG. 2) is formed on the polygon mirror 18 having a substantially cup-like hollow on the side of its lower end at which the polygon mirror 18 is in contact with the flange 17. When the polygon mirror 18 is press-fitted into the flange 17, the flange 17 and the press fitting guide part 18e of the polygon mirror 18 are fitted to each other in a minute gap.

A thin-walled elastic deformation part 18f (FIG. 3) easily deformable in the axial directions is formed at the upper end of the polygon mirror 18, extending from the press fitting outside diameter part 18a.

In order to cause the rotary body 3 to rotate at high speed, balance correction is performed at upper and lower correction surfaces 18b and 14a of the rotary body 3. A center of gravity 3a of the rotary body 3 is disposed at or around the center of the dynamic pressure bearing in the axial directions. This makes it possible to correct the balance of the rotary body 3 with high accuracy, so that it is possible to reduce unbalance vibration to an extremely low level.

Wiring patterns connected to the winding coil 12a and the Hall elements 13 are formed on the printed board 11. A driver circuit 20 sequentially switches current to the winding coil 12a in accordance with the position detection signals of the Hall elements 13, thereby controlling the rotary body 3 so that the rotary body 3 rotates at a constant speed.

The reflection surfaces 18c and 18d of the polygon mirror 18 are integrally formed by ultraprecise cutting by the following method.

In the first process, the sleeve 16 and the flange 17 are fixed by shrink fitting.

In the second process, the interior surface of the sleeve 16 to serve as the dynamic pressure bearing surface 16a is finished with high accuracy.

In the third process, the mirror finishing reference surface 17b used in forming the reflection surfaces 18c and 18d of the polygon mirror 18 is formed on the flange 17. As shown in FIG. 5, a processing jig (tapered rod) 22 is passed through the bore of the sleeve 16, so that the sleeve 16 is fixed. Cutting with a processing blade 23 is performed so that the mirror finishing reference surface 17b, perpendicular with high accuracy to the center axis of the bore of the sleeve 16, that is, the center axis of the dynamic pressure bearing, is formed on the flange 17. In the fourth process, the polygon mirror 18 is press-fitted onto the flange 17.

The polygon mirror 18 is press-fitted onto the flange 17 with the press fitting guide parts 17d and 18e to be fitted to each other in a minute gap serving as guides, thereby preventing the center axes of the flange 17 and the polygon mirror 18 from being misaligned. The press fitting parts 17a and 18a of the flange 17 and the polygon mirror 18, respectively, pass over a fine step to be press-fitted to each other. When the press fitting is completed, the steps formed on the press fitting parts 17a and 18a of the flange 17 and the polygon mirror 18 engage each other as shown in FIG. 3. Further, when the press fitting is completed, the thin-walled elastic deformation part 18f of the polygon mirror 18 elastically deforms slightly in the axial direction, so that the flange 17 and the polygon mirror 18 are fixed (elastically adhered by pressure) with their contact surfaces adhering to each other.

In the fifth process, with the flange 17 being fixed at its mirror finishing reference surface 17b, the highly accurate reflection surfaces 18c and 18d are formed at a fixed angle to the center axis of the bore of the sleeve 16 by ultraprecise cutting.

In the first embodiment, the rotary body 3 includes the sleeve 16 having the dynamic pressure bearing surface 16a formed thereon, the flange 17 fixed to the sleeve 16, the polygon mirror 18 press-fitted and fixed to the flange 17, and the rotor magnet 14, which is a permanent magnet for driving.

The polygon mirror 18 has a substantially cup-like hollow, and is fixed so that the dynamic pressure bearing surface 16a of the sleeve 16 overlaps part or all of the reflection surfaces 18c and 18d of the polygon mirror 18 at a position in the directions of the rotation axis.

This reduces the deformation of the mirror reflection surfaces 18c and 18d due to a change in temperature. Further, since the center of gravity 3a of the rotary body 3 is disposed in the substantial center of the dynamic pressure bearing, it is possible to correct the balance of the rotary body 3 with high accuracy. Accordingly, the unbalance of the rotary body 3 due to temperature is controlled, so that vibration is reduced.

The mirror finishing reference surface 17b perpendicular to the dynamic pressure bearing surface 16a of the sleeve 16 is formed on the flange 17. This reduces variations in the angle of the reflection surface, thus increasing the scanning position accuracy of optical scanning. This results in excellent optical characteristics.

The mirror finishing reference surface 17b, which has highly accurate perpendicularity to the rotation center axis of the dynamic pressure bearing, is on the outer side of the rotary body 3 with the sleeve 16, the flange 17, and the polygon mirror 18 being integrated, so as to be employable in performing mirror finishing of the reflection surfaces 18c and 18d.

The mirror finishing reference surface 17b is formed on the other side of the mirror contact surface 17c from the polygon mirror 18. Accordingly, the mirror finishing reference surface 17b having highly accurate perpendicularity to the rotation center axis of the dynamic pressure bearing is on the outer side of the rotary body 3 with the sleeve 16, the flange 17, and the polygon mirror 18 being integrated, thus being employable in performing mirror finishing of the reflection surfaces 18c and 18d.

The flange 17 and the polygon mirror 18 are press-fitted and fixed with the press fitting inside diameter part 17a formed on the flange 17 and the press fitting outside diameter part 18a formed on the polygon mirror 18 being press-fitted and fixed. That is, the press fitting fixation part of the flange 17 and the polygon mirror 18 is a press fitting part where the press fitting inside diameter part 17a formed on the flange 17 and the press fitting outside diameter part 18a formed on the polygon mirror 18 are press-fitted and fixed. This makes it difficult for stress due to the press fitting and fixation of the flange 17 and the polygon mirror 18 to be transmitted to the reflection surfaces 18c and 18d of the polygon mirror 18, thereby minimizing the deformation of the reflection surfaces 18c and 18d.

The diameter D2 of the press fitting parts 17a and 18a is greater than the diameter D1 of the dynamic pressure bearing. Accordingly, it is possible to form the mirror finishing reference surface 17b having highly accurate perpendicularity to the rotation center axis of the dynamic pressure bearing. The rotor magnet 14, which is a permanent magnet for driving, is fixed to the inner wall of the large-diameter lower cylindrical part of the flange 17. This minimizes the deformation of the reflection surfaces 18c and 18d due to fixation of the rotor magnet 14.

As a result, it is possible to provide the light deflector of the first embodiment in which it is difficult for stress due to the press fitting and fixation of the flange 17 and the polygon mirror 18 to be transmitted to the reflection surfaces 18c and 18d of the polygon mirror 18; the deformation of the reflection surfaces 18c and 18d can be minimized; and the mirror finishing reference surface 17b having highly accurate perpendicularity to the rotation center axis of the dynamic pressure bearing can be formed.

Since the sleeve 16 is formed of ceramic, it is possible to increase the wear resistance of the dynamic pressure bearing surface 16a, thus making it possible to prolong its useful service life. The sleeve 16 and the flange 17 are fixed by shrink fitting. This prevents the joining of the sleeve 16 and the flange 17 having different coefficients of liner expansion from being loosened by a change in temperature. Thus, the sleeve 16 and the flange 17 are firmly fixed, so that change in vibration is reduced.

The rotary part 19 of the magnetic bearing is concentrically fixed to the center part of the polygon mirror 18. This reduces variations in the vertical positions of the reflection surfaces 18c and 18d, thus increasing their positional accuracy. The reflection surface 18c and 18d are formed on the polygon mirror 18 in multiple tiers in the axial directions. This enables optical scanning with light from multiple light sources.

As a result, it is possible to provide the light deflector of the first embodiment in which the deformation of the reflection surfaces 18c and 18d due to fixation of a permanent magnet for driving is minimized; the dynamic pressure bearing surface 16a has high wear resistance and a long useful service life; and the sleeve 16 and the flange 17 having different coefficients of liner expansion are firmly fixed with their joining being prevented from being loosened by a change in temperature, so that change in vibration is reduced.

The reflection surfaces 18c and 18d are formed on the polygon mirror 18 by mirror finishing after integrating the sleeve 16 and the flange 17 with the polygon mirror 18. Accordingly, it is possible to form the highly accurate reflection surfaces 18c and 18d having a constant angle to the center axis (rotation center axis) of the dynamic pressure bearing surface 16a of the sleeve 16.

According to the above-described configuration, the press fitting guide parts 17d and 18e are formed on the flange 17 and the polygon mirror 18, respectively. This prevents an increase in initial unbalance due to misalignment of the center axes of the flange 17 and the polygon mirror 18 at the time of press-fitting the polygon mirror 18 to the flange 17.

The press fitting guide part (outside diameter part for guiding) 17d and the press fitting guide part (inside diameter part for guiding) 18e are configured to be fitted to each other in a minute gap. Accordingly, the press fitting guide parts 17d and 18e can be formed easily.

When the polygon mirror 18 is press-fitted and fixed to the flange 17, the press fitting guide part 17d of the flange 17 is positioned on the press fitting start side (on which press fitting is started) compared with the press fitting guide part 18e of the polygon mirror 18. Accordingly, it is possible to reduce the contact portion of the press fitting guide parts 17d and 18e of the flange 17 and the polygon mirror 18 after press fitting, thereby minimizing the deformation of the reflection surfaces 18c and 18d of the polygon mirror 18.

The elastic deformation part 18f that is elastically deformable in the axial directions with ease is provided in the polygon mirror 18. This elastically fixes the polygon mirror 18 at the time of press fitting, thus preventing displacement of the polygon mirror 18 due to a change in temperature.

The elastic deformation part 18f of the polygon mirror 18 is formed of a thin-walled connection part connecting the press fitting outside diameter part 18a and the reflection surfaces 18c and 18d. Accordingly, it is possible to form the elastic deformation part 18f with ease.

A coming-off prevention part is provided to the press fitting parts 17a and 18a of the flange 17 and the polygon mirror 18. As a result, the press fitting parts 17a and 18a of the flange 17 and the polygon mirror 18 are prevented from being disengaged from each other and coming off while an elastic force in the axial directions works on the flange 17 and the polygon mirror 18 so as to keep the flange 17 and the polygon mirror 18 adhering to each other.

The coming-off prevention part is formed by a minute step provided on each of the press fitting part 17a of the flange 17 and the press fitting part 18a of the polygon mirror 18. Accordingly, it is possible to form the coming-off prevention part with ease.

The space 17e overlapping at least the reflection surfaces 18c and 18d of the polygon mirror 18 at a position in the directions of the rotation axis is formed between the flange 17 and the polygon mirror 18. This prevents deformation of the reflection surfaces 18c and 18d of the polygon mirror 18 due to a change in temperature caused by the contact of the exterior surface of the flange 17 and the interior surface of the polygon mirror 18.

### Second Embodiment

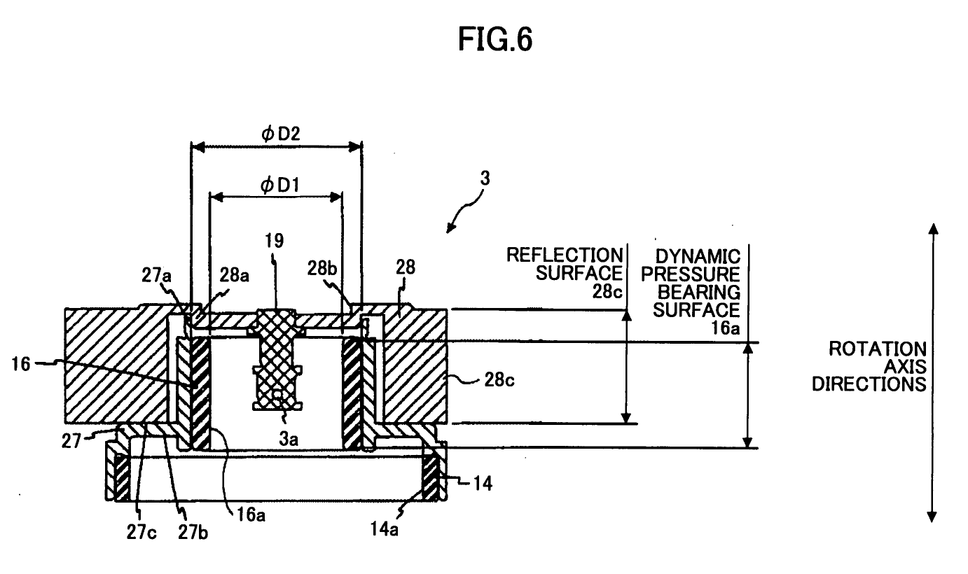

FIG. 6 is a cross-sectional view of a light deflector according to a second embodiment of the present invention. In FIG. 6, the same elements as those of FIGS. 1 through 4 are referred to by the same numerals, and a description thereof is omitted. The light deflector of the second embodiment is different from the light deflector of the first embodiment in the configuration of a rotary body. A press fitting inside diameter part 27a is formed at the upper end of a flange 27. A press fitting outside diameter part 28a of a polygon mirror 28 is press-fitted into and fixed to the press fitting inside diameter part 27a.

The flange 27 and the polygon mirror 28 have substantially the same coefficient of linear expansion. The press fitting inside diameter part 27a and the press fitting outside diameter part 28a are through holes having a diameter D2 greater than the diameter D1 of the dynamic pressure bearing. A reference surface for mirror finishing (mirror finishing reference surface) 27b perpendicular to the dynamic pressure bearing surface 16a of the sleeve 16 is formed on the flange 27. The mirror finishing reference surface 27b is formed on the other side of a mirror contact surface 27c from the polygon mirror 28.

A reflection surface 28c thick in the axial directions is formed on the exterior surface of the polygon mirror 28. A substantially cup-like hollow is formed in the polygon mirror 28. The polygon mirror 28 is fixed with the dynamic pressure bearing surface 16a formed on the sleeve 16 overlapping part of the deflection reflection surfaces 28c formed on the polygon mirror 28 at a position in the directions of the rotation axis. The rotary part 19 of an attraction-type magnetic bearing is fixed to the center of the upper part of the polygon mirror 28 by press fitting.

The rotary part 19 of the attraction-type magnetic bearing has an exterior cylindrical surface. The rotary part 19 is disposed so that a magnetic gap is formed between the exterior cylindrical surface and the central circular holes of the first fixed yoke plate 9 and the second fixed yoke plate 10 and that the exterior cylindrical surface is concentric with the rotation center axis (FIGS. 1 and 3). A permanent magnet or a steel-based ferromagnetic material is employed as a material for the rotary part 19 of the attraction-type magnetic bearing.

In order to cause the rotary body 3 to rotate at high speed, balance correction is performed at an upper correction surface 28b and the lower correction surface 14a of the rotary body 3. The center of gravity 3a of the rotary body 3 is disposed at or around the center of the dynamic pressure bearing in the axial directions. This makes it possible to correct the balance of the rotary body 3 with high accuracy, so that it is possible to reduce unbalance vibration to an extremely low level.

It is possible to provide a method for forming a reflection surface that is highly accurate with reduced variations in its vertical position and a constant angle to the center axis (rotation center axis) of the dynamic pressure bearing surface 16a of the sleeve 16, and enables optical scanning with light from multiple light sources.

### Third Embodiment

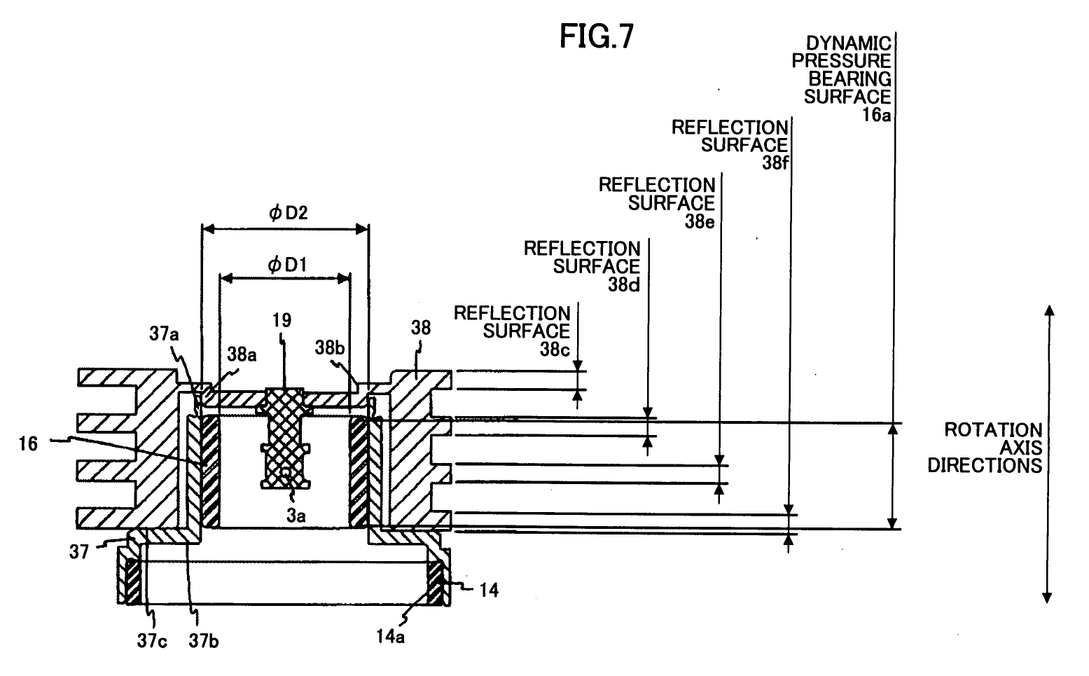

FIG. 7 is a cross-sectional view of a light deflector according to a third embodiment of the present invention. The light deflector of the third embodiment is different from the light deflector of the first embodiment in the configuration of a rotary body. A press fitting inside diameter part 37a is formed at the upper end of a flange 37. A press fitting outside diameter part 38a of a polygon mirror 38 is press-fitted into the press fitting inside diameter part 37a to be fixed to the interior surface thereof.

The flange 37 and the polygon mirror 38 are formed of materials having substantially the same coefficient of linear expansion. The press fitting inside diameter part 37a and the press fitting outside diameter part 38a are through holes having a diameter D2 greater than the diameter D1 of the dynamic pressure bearing.

A reference surface for mirror finishing (mirror finishing reference surface) 37b perpendicular to the dynamic pressure bearing surface 16a of the sleeve 16 is formed on the flange 37. The mirror finishing reference surface 37b is formed on the other side of a mirror contact surface 37c from the polygon mirror 38.

Four reflection surfaces 38c, 38d, 38e, and 38f are formed integrally with the polygon mirror 38 in the axial directions. A substantially cup-like hollow is formed in the polygon mirror 38. The polygon mirror 38 is fixed with the dynamic pressure bearing surface 16a formed on the sleeve 16 overlapping part of the reflection surfaces 38c, 38d, 38e, and 38f formed on the polygon mirror 38, that is, the reflection surfaces 38d, 38e, and 38f, at a position in the directions of the rotation axis. The rotary part 19 of an attraction-type magnetic bearing is fixed to the center of the upper surface of the polygon mirror 38 by press fitting. The rotary part 19 of the attraction-type magnetic bearing has an exterior cylindrical surface. The rotary part 19 is disposed so that a magnetic gap is formed between the exterior cylindrical surface and the central circular holes of the first fixed yoke plate 9 and the second fixed yoke plate 10 and that the exterior cylindrical surface is concentric with the rotation center axis. A permanent magnet or a steel-based ferromagnetic material is employed as a material for the rotary part 19 of the attraction-type magnetic bearing.

In order to cause the rotary body 3 to rotate at high speed, balance correction is performed at an upper correction surface 38b and the lower correction surface 14a of the rotary body 3. The center of gravity 3a of the rotary body 3 is disposed at or around the center of the dynamic pressure bearing in the axial directions. This makes it possible to correct the balance of the rotary body 3 with high accuracy, so that it is possible to reduce unbalance vibration to an extremely low level.

### Fourth Embodiment

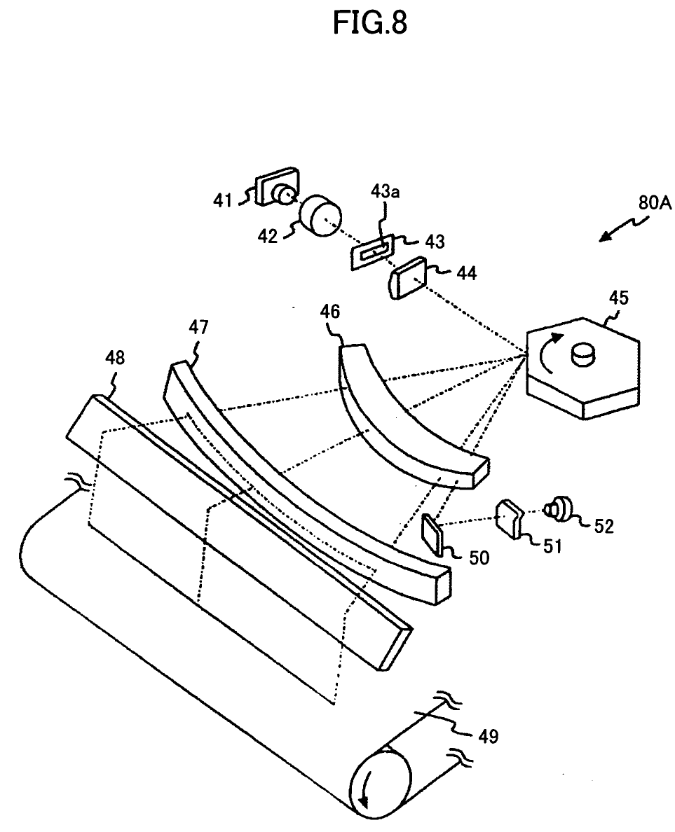

FIG. 8 is a perspective view of an optical scanning device according to a fourth embodiment of the present invention. FIG. 8 shows part of the configuration of an optical scanning device 80A including a light deflector according to the present invention. The optical scanning device 80A is of a single beam type.

The optical scanning device 80A according to this embodiment includes a light source 41, a coupling lens 42, an aperture 43, a cylindrical lens 44, a polygon mirror 45, lenses 46 and 47, a mirror 48, a photosensitive body 49, a mirror 50, a lens 51, and a light-receiving element 52.

The light source 41 is a semiconductor laser element emitting light for optical scanning. The coupling lens 42 adapts the light emitted from the light source 41 to an optical system. The aperture 43 provides the light beam for optical scanning with a predetermined shape. The cylindrical lens 44 gathers the incident light beam in the sub scanning direction.

The polygon mirror 45 is a light deflector according to the present invention. The polygon mirror 45 reflects the incident light on its deflection reflection surface. The lenses 46 and 47 focus the light beam on the belt-like photosensitive body 49. The mirror 48 bends the optical path of the light beam so as to guide the light beam to the photosensitive body 49.

An electrostatic latent image is formed on the photosensitive body 49 in accordance with the light beam with which the photosensitive body 49 is illuminated. The mirror 50 and the lens 51 concentrate the light beam onto the light-receiving element 52. The light-receiving element 52 is a photodetector element such as a photodiode.

The beam emitted from the light source 41, which is a semiconductor laser element, is a divergent pencil of rays, and is coupled to the subsequent optical system by the coupling lens 42. The form of the coupled beam corresponds to the optical characteristics of the subsequent optical system. The beam may be a slightly divergent pencil of rays, a slightly convergent pencil of rays, or a parallel pencil of rays.

When the beam passing through the coupling lens 42 passes through an opening 43a of the aperture 43, the beam is subjected to “beam shaping” with the opening 43a blocking the peripheral part of the beam where light intensity is low. Thereafter, the beam enters the cylindrical lens 44, which is a “linear imaging optical system.”

The cylindrical lens 44 has a substantially half tube shape. The cylindrical lens 44 has a powerless direction (a direction in which light is not refracted) in the main scanning direction, and has positive power (power to converge light) in the sub scanning direction. The cylindrical lens 44 converges the incident beam in the sub scanning direction, and concentrates the beam on and around the deflection reflection surface of the polygon mirror 45 serving as a “light deflector.”

While being deflected in a constant angular velocity manner with the rotation of the polygon mirror 45 at a constant velocity, the beam reflected from the deflection reflection surface of the polygon mirror 45 passes through the two lenses 46 and 47 forming a “scanning optical system,” and has its optical path bent by the bending mirror 48 so as to be focused into a light spot on the photoconductive photosensitive body 49 forming the substance of a “surface to be scanned (scanning surface) and scan the scanning surface.

The beam enters the mirror 50 before scanning the scanning surface, and is gathered onto the light-receiving element 52 by the lens 51. The timing of writing onto the photosensitive body 49 is determined by a control part (not graphically illustrated) based on the output of the light-receiving element 52.

Thus, a light deflector according to the present invention is applicable to an optical scanning device of a single beam type. In the optical scanning device of a single beam type to which the light deflector according to the present invention is applied, the reflection surface of the polygon mirror 45 serving as the light deflector is maintained with high accuracy. As a result, the shape of a scanning beam is constant, thus making it possible to perform optical scanning with stability.

### Fifth Embodiment

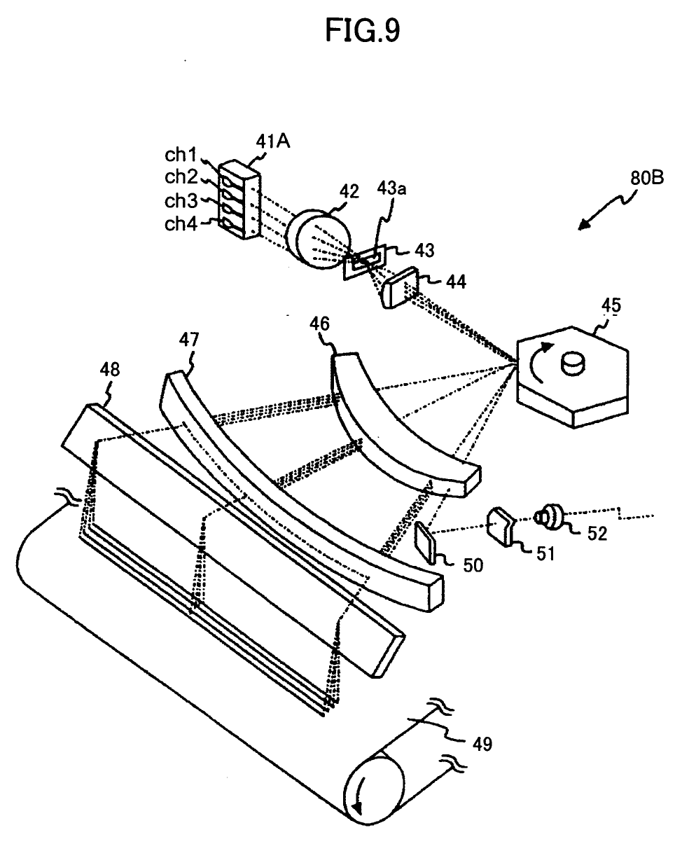

FIG. 9 is a perspective view of an optical scanning device according to a fifth embodiment of the present invention. FIG. 9 shows part of an optical scanning device 80B of a multi-beam type to which a light deflector according to the present invention is applied. In FIG. 9, the same elements as those of FIG. 8 are referred to by the same numerals.

A light source 41A is a semiconductor laser array in which four light emission sources ch1 through ch4 are arranged at equal intervals in an array. In this embodiment, the light emission sources ch1 through ch4 are arranged in the sub scanning direction. Alternatively, the semiconductor laser array 41A may be inclined so that the direction of the light emission source array is inclined to the main scanning direction.

Referring to FIG. 9, each of four beams emitted from the four light emission sources ch1 through ch4, which is a divergent pencil of rays of which the long axis direction of the elliptic far field pattern is directed in the main scanning direction, is coupled to the subsequent optical system by the coupling lens 42 common to the four beams.

The form of each coupled beam corresponds to the optical characteristics of the subsequent optical system. The beam may be a slightly divergent pencil of rays, a slightly convergent pencil of rays, or a parallel pencil of rays.

Each of the four beams passing through the coupling lens 42 is subjected to “beam shaping” by the aperture 43, and is converged in the sub scanning direction by the action of the cylindrical lens 44 serving as a “common linear imaging optical system.”

The four beams converged in the sub scanning direction form respective linear images having length in the main scanning direction, separated from one another in the sub scanning direction, on and around the deflection reflection surface of the polygon mirror 45 serving as a “light deflector.”

The four beams deflected in a constant angular velocity manner by the deflection reflection surface of the polygon mirror 45 pass through the two lenses 46 and 47 forming a “scanning optical system,” and have their respective optical paths bent by the bending mirror 48.

The four beams having their respective optical paths bent are focused into four light spots separated in the sub scanning direction on the photosensitive body 49 forming the substance of the “scanning surface,” and simultaneously scan the scanning surface with four scanning lines.

One of the four beams enters the mirror 50 and is gathered onto the light-receiving element 52 by the lens 51 before scanning the scanning surface. The timing of writing onto the photosensitive body 49 by the four beams is determined by a control part (not graphically illustrated) based on the output of the light-receiving element 52.

The “scanning optical system” according to the present invention is an optical system that focuses four beams simultaneously deflected by a light deflector (the polygon mirror 45) into four light spots on the scanning surface of the photosensitive body 49, and is configured by the two lenses 46 and 47.

Thus, a light deflector according to the present invention is applicable to an optical scanning device of a multi-beam type. In the optical scanning device of a multi-beam type to which the light deflector according to the present invention is applied, the reflection surface of the polygon mirror 45 serving as the light deflector is maintained with high accuracy. As a result, the shape of a scanning beam is constant, thus making it possible to perform optical scanning with stability.

### Sixth Embodiment

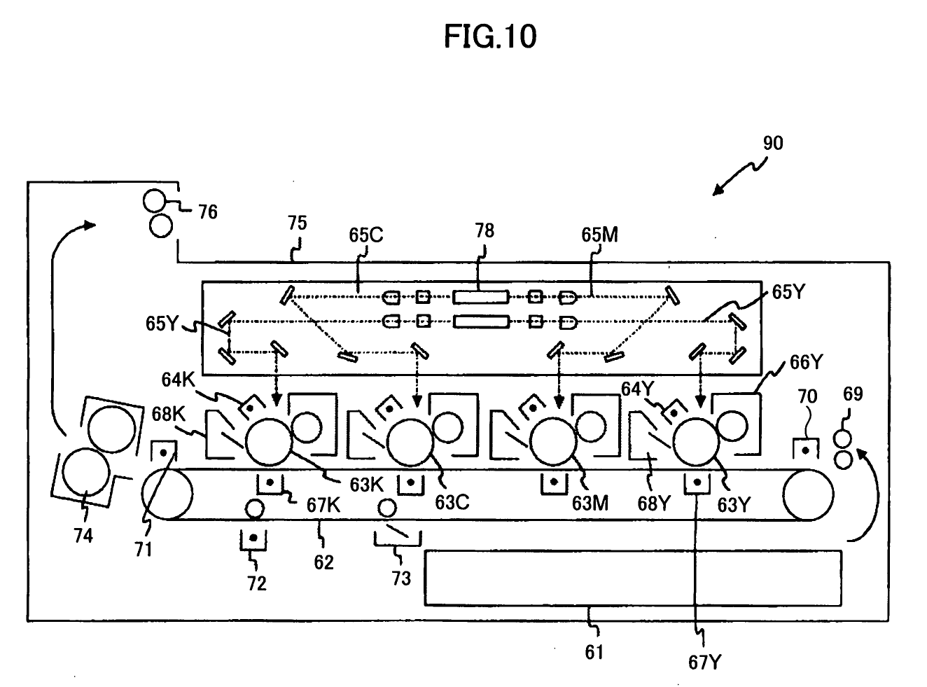

FIG. 10 is a schematic diagram showing a tandem full-color laser printer 90 according to a sixth embodiment of the present invention as an image-forming apparatus including a light deflector according to the present invention. Referring to FIG. 10, a conveyor belt 62, which is disposed horizontally to convey transfer paper (not graphically illustrated) fed from a paper feed cassette 61, is provided in the lower part of the laser printer (image-forming apparatus) 90. A photosensitive body 63Y for yellow (Y), a photosensitive body 63M for magenta (M), a photosensitive body 63C for cyan (C), and a photosensitive body 63K for black (K) are disposed at equal intervals in order described from the upstream side above the conveyor belt 62. In the following, the additional letters Y, M, C, and K are added appropriately to reference numerals in order to distinguish between the corresponding colors.

These photosensitive bodies 63Y, 63M, 63C, and 63K are formed to have the same diameter. Process members are disposed in order around each of the photosensitive bodies 63Y, 63M, 63C, and 63K in accordance with the process of electrophotography.

Taking the photosensitive body 63Y as an example, a charger 64Y, an optical scanning device 65Y, a development unit 66Y, a transfer charger 67Y, a cleaning unit 68Y, etc., are disposed in this order around the photosensitive body 63Y. This is the same with the other photosensitive bodies 63M, 63C, and 63K.

That is, according to this embodiment, each of the photosensitive bodies 63Y, 63M, 63C, and 63K serves as a surface to be illuminated (illumination surface) set for the corresponding color. The optical scanning devices 65Y, 65M, 65C, and 65K are provided for the photosensitive bodies 63Y, 63M, 63C, and 63K, respectively, with a one-to-one correspondence.

Further, registration rollers 69 and a belt charger 70 are provided around the conveyor belt 62 so as to be positioned on the upstream side of the photosensitive body 63Y. Further, a belt separation charger 71, a discharging charger 72, a cleaning unit 73, etc., are provided in order around the conveyor belt 62 so as to be positioned on the downstream side of the photosensitive body 63K.

A fusing unit 74 is provided on the downstream side of the belt separation charger 71 in the paper conveyance direction. The fusing unit 74 is connected to a paper output tray 75 through paper ejection rollers 76.

In the above-described configuration, for instance, at the time of a full-color (multicolor) mode, the optical scanning devices 65Y, 65M, 65C, and 65K perform optical scanning with respective light beams so as to form respective electrostatic latent images on the corresponding photosensitive bodies 63Y, 63M, 63C, and 63K based on respective image signals for the colors of Y, M, C, and K.

These electrostatic latent images are developed into toner images with toners of the corresponding colors, and are successively transferred onto the transfer paper so as to be superposed on one another. The transfer paper is conveyed, being electrostatically attracted and adhered to the conveyor belt 62.

The toner images of the respective colors superposed on one another on the transfer paper are fixed onto the transfer paper as a full-color image by the fusing unit 74. The transfer paper on which the full-color image is fixed is ejected onto the paper output tray 75 by the paper ejection rollers 76.

At the time of a black-color mode (monochrome mode), the photosensitive bodies 63Y, 63M, and 63C and their respective process members are made inactive, and the optical scanning device 65K performs optical scanning with a light beam based on an image signal for black color so that an electrostatic latent image is formed only on the photosensitive body 63K.

This electrostatic latent image is developed into a toner image with black toner, and is transferred onto the transfer paper electrostatically attracted and adhered to the conveyor belt 62 and conveyed thereon. The toner image transferred onto the transfer paper is fixed onto the transfer paper as a monochrome image by the fusing unit 74. The transfer paper on which the monochrome image is fixed is ejected onto the paper output tray 75 by the paper ejection rollers 76.

Thus, an optical scanning device according to the present invention is applicable to a tandem full-color laser printer. In the tandem full-color laser printer 90, to which a light deflector according to the present invention is applied, the reflection surfaces of a light deflector 78 shared by the optical scanning devices 65Y, 65M, 65C, and 65K and having two mirrors formed in tiers in axial directions thereon are maintained with high accuracy. As a result, the shape of a scanning beam is constant, thus making it possible to perform optical scanning with stability.

According to the above-described embodiments, it is possible to provide a light deflector for high-speed rotation in which: the deformation of a mirror reflection surface due to a change in temperature is minimized; it is possible to correct the balance of a rotary body with accuracy by disposing the center of gravity of the rotary body in the substantial center of a dynamic pressure bearing, so that a change in the balance (unbalance) of the rotary body 3 due to temperature is controlled so as to reduce vibration; and a polygon mirror is elastically fixed at the time of its press fitting so as to prevent displacement of the polygon mirror due to a change in temperature.

Further, according to the above-described embodiments, it is possible to provide a light deflector in which: the deformation of a mirror reflection surface due to a change in temperature is minimized; it is possible to correct the balance of a rotary body with accuracy by disposing the center of gravity of the rotary body in the substantial center of a dynamic pressure bearing, so that a change in the balance (unbalance) of the rotary body 3 due to temperature is controlled so as to reduce vibration; and the press fitting parts of a polygon mirror and a flange are prevented from coming off even if the polygon mirror and the flange are fixed with an elastic force in an axial direction working on the polygon mirror and the flange.

Further, according to the above-described embodiments, it is possible to provide a light deflector in which: the deformation of a mirror reflection surface due to a change in temperature is minimized; it is possible to correct the balance of a rotary body with accuracy by disposing the center of gravity of the rotary body in the substantial center of a dynamic pressure bearing, so that a change in the balance (unbalance) of the rotary body 3 due to temperature is controlled so as to reduce vibration; and deformation of the mirror reflection surface due to a change in temperature caused by the contact of the exterior part of a flange and the interior part of a polygon mirror is prevented.

According to the above-described embodiments, it is possible to provide an optical scanning device in which the reflection surface of a light deflector is maintained with high accuracy so that the shape of a scanning beam is constant and stable, and to provide an image-forming apparatus of high image quality including the optical scanning device.

### Seventh Embodiment

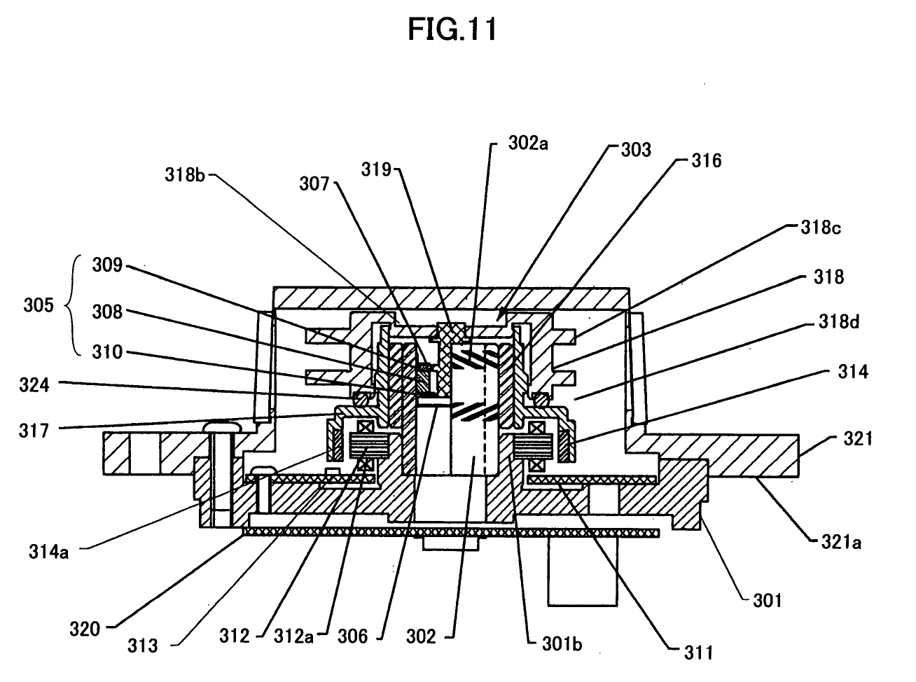

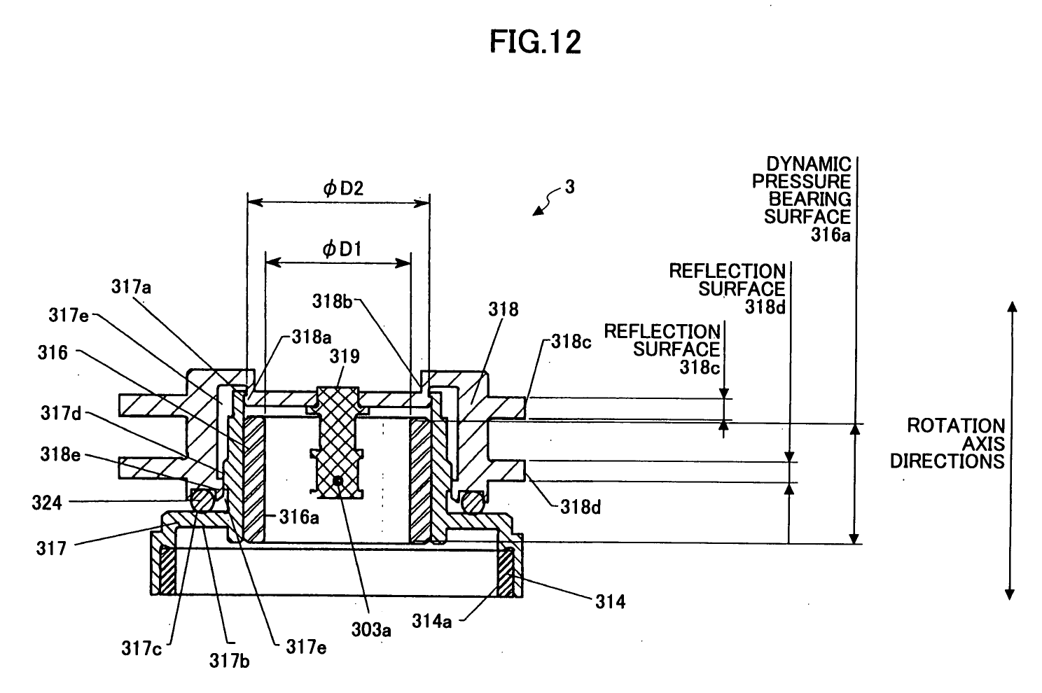

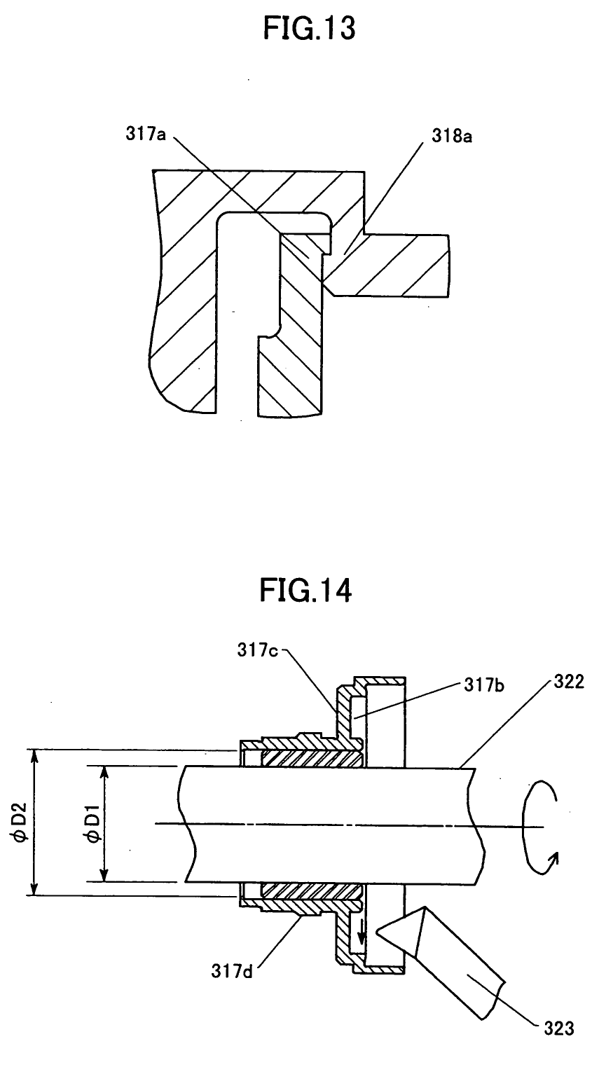

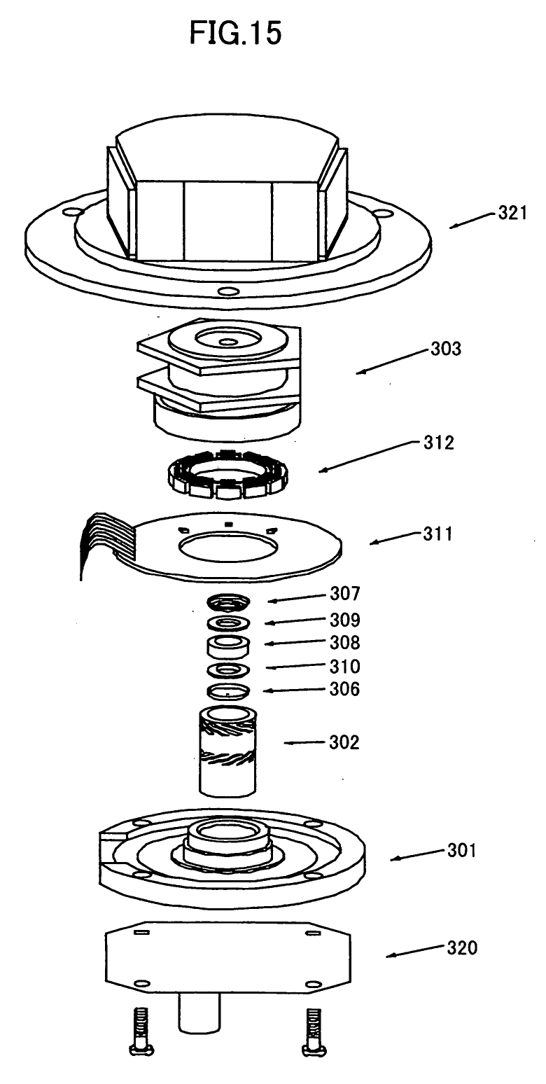

A description is given, with reference to FIGS. 11 through 15, of a configuration and an operation of a light deflector using a dynamic pressure air bearing according to a seventh embodiment of the present invention. The dynamic pressure air bearing may also employ gas other than air as lubricating fluid. FIG. 11 is a cross-sectional view of the light deflector using a dynamic pressure air bearing according to the seventh embodiment. FIG. 12 is a cross-sectional view of a rotary body of the light deflector of FIG. 11. FIG. 13 is an enlarged view of a mirror press fitting part of the light deflector of FIG. 11. FIG. 14 is a cross-sectional view of part of the light deflector of FIG. 11 for illustrating a procedure for processing a reference surface for mirror finishing. FIG. 15 is an exploded perspective view of the light deflector of FIG. 11.

Referring to FIGS. 11 through 15, the light deflector has a cover case 321 shaped like a flanged bottomed cylinder turned bottom up. The lower surface of a part of the cover case 321 corresponding to the flange is finished with accuracy so as to serve as a reference surface 321a for attachment to an optics housing. A housing 301 is fixed to the cover case 321 on its lower side. The housing 301 is shaped like a disk. A cylindrical or through hole-like bearing attachment part 301b is formed in the center of the upper surface of the housing 301 so as to be integrated therewith. A cylindrical fixed shaft 302 forming a dynamic pressure bearing is fixed to the interior circumferential surface of the bearing attachment part 301b by press fitting.

Multiple oblique grooves 302a for forming the dynamic pressure bearing are formed on the surface of the cylindrical fixed shaft 302, being arranged in a circumferential direction. The grooves 302a are formed on the fixed shaft 302 at first and second points apart from each other by a predetermined distance in a direction of the center axis of the fixed shaft 302. The grooves 302a formed at the first point and the grooves 302a formed at the second point are inclined in directions opposite from each other. A cylindrical sleeve 316 is placed around the fixed shaft 302 with a minute bearing gap formed between the exterior circumferential surface of the fixed shaft 302 and the interior circumferential surface of the sleeve 316. A rotary body 303 includes the sleeve 316, a flange 317 fitted to the sleeve 316 on its outer side so as to be integrated therewith, and a polygon mirror 318 fitted to the flange 317 on its upper outer side so as to be integrated therewith. When the rotary body 303 starts rotating, the grooves 302a at the first and second points increase the air pressure of the bearing gap formed between the sleeve 316 and the fixed shaft 302 so that the rotary body 303 is supported in a radial direction with respect to the fixed shaft 302 without contact therewith.

A fixation part 305 of an attraction-type magnetic bearing is fixed to the inside of the fixed shaft 302. A flat plate-like cap 306 and an annular stopper 307 are press-fitted and fixed to the internal cylindrical part (hollow part) of the fixed shaft 302 so as to hold and fix the fixation part 305 between the cap 306 and the stopper 307 in the axial directions of the fixed shaft 302. At least one fine hole of approximately 0.2-0.5 mm in diameter for attenuating vertical vibration by using viscous resistance at the time of air passage is formed in the center part of the cap 306. A non-magnetic material such as stainless steel is used as a material for both the cap 306 and the stopper 307.

The fixation part 305 of the attraction-type magnetic bearing includes an annular permanent magnet 308 magnetized with two polarities in the directions of a rotation axis, a first fixed yoke plate 309 of a ferromagnetic material with a central circular hole having a diameter smaller than the inside diameter of the annular permanent magnet 308, and a second fixed yoke plate 310 of a ferromagnetic material with a central circular hole having a diameter smaller than the inside diameter of the annular permanent magnet 308. The annular permanent magnet 308 is sandwiched between the first fixed yoke plate 309 and the second fixed yoke plate 310 in the axial directions. The first fixed yoke plate 309 and the second fixed yoke plate 310 are disposed and fixed inside the fixed shaft 302 so that the central circle of the first fixed yoke plate 309 and the central circle of the second fixed yoke plate 310 are concentric with the rotation center axis. A permanent magnet based on a rare earth material is suitable for the annular permanent magnet 308. Other types of magnets may also be used. A steel-based plate is used as a material for the fixed yoke plates 309 and 310.

A printed board 311 in which a hole escaping the bearing attachment part 301b is formed in the center part is disposed on the upper surface of the housing 301, and is fixed thereto with screws. A stator 312 is fitted and fixed to the bearing attachment part 301b of the housing 301 on its outer side above the printed board 311. A conductive material such as an aluminum alloy is used as a material for the housing 301. Accordingly, eddy current flows in the housing 301 because of an alternating field due to the rotation of a rotor magnet 314. The printed board 311 may be formed of an iron substrate in order to prevent this eddy current from increasing motor loss. Hall elements 313, which are position detecting elements for switching current to a winding coil (motor winding) 312a, are mounted on the printed board 311.

A motor part includes the rotor magnet 314 attached to the rotary body 303, the winding coil 312a, the stator 312 around which the winding coil 312a is wound, the printed board 311 to which the winding coil 312a is connected, and the Hall elements 313 mounted on the printed board 311. The stator 312 is a lamination of silicon steel plates in order to prevent eddy current from flowing therein to increase core loss. Referring to FIG. 12, the rotary body 303 includes the sleeve 316, the flange 317 fixed to the outside of the sleeve 316, the polygon mirror 318 coupled and fixed to the flange 317, a rotary part 319 of the magnetic bearing fixed to the polygon mirror 318, the rotor magnet 314 fixed to the flange 317, and an O-ring 324 placed between the flange 317 and the polygon mirror 318. The sleeve 316 is formed of ceramic, and the flange 317 is formed of an aluminum alloy. The sleeve 316 and the flange 317 are fixed by shrink fitting.

The flange 317 corresponds to the rotor housing of a motor. The rotor magnet 314 for a motor is bonded or press-fitted to the lower part of the flange 317. The rotor magnet 314 may be formed of separate permanent magnets provided in a circumferential direction. In this case, however, the rotor magnet 314 is shaped like a ring so as to be easily bonded or press-fitted to the flange 317. The rotor magnet 314 is magnetized to have alternate north and south poles in its circumferential directions. A plastic magnet having substantially the same coefficient of linear expansion as the flange 317 may be used as a material for the rotor magnet 314, and be fixed to the flange 317 by press fitting. This makes it possible to reduce a change in the unbalance vibration of the rotary body 303 due to a change in temperature. Accordingly, this is more suitable for a motor for high-speed rotation.

As shown in detail in FIG. 13, the upper end of the flange 317 slightly projects inward so as to form a circular (circumferential) step on the entire upper end. This part of the flange 317 on which the step is formed forms a press fitting inside diameter part 317a. The ceiling part of the upper part of the polygon mirror 318 is formed to have an inward depressed shape, thereby forming a cylindrical surface to which the press fitting inside diameter part 317a of the flange 317 is fitted. A press fitting outside diameter part 318a slightly projecting outward is formed around the cylindrical surface. This press fitting outside diameter part 318a is fixed to the press fitting inside diameter part 317a of the flange 317 by press fitting. The press fitting outside diameter part 318a of the polygon mirror 318 is formed to be slightly greater in diameter than the press fitting inside diameter part 317a of the flange 317. Both the flange 317 and the polygon mirror 318 are formed of an aluminum alloy, but employ different types of alloys although the difference is less than or equal to several percent in the coefficient of linear expansion. A pure aluminum-based alloy with a high aluminum content is used for the polygon mirror 318 in order to form a highly reflective mirror surface. The coefficient of linear expansion of the material of the polygon mirror 318 is approximately 24.6×10⁻⁶/° C. On the other hand, a structural material aluminum alloy is employed for the flange 317. The coefficient of linear expansion of the material of the flange 317 is approximately 23.8×10⁻⁶/° C. Thus, the flange 317 is smaller in the coefficient of linear expansion than the polygon mirror by approximately 3%.

Referring to FIG. 12, the diameter D2 of the press fitting inside diameter part 317a and the press fitting outside diameter part 18a is greater than the diameter D1 of the dynamic pressure bearing. A reference surface for mirror finishing (mirror finishing reference surface) 317b is formed on the flange 317 in a direction perpendicular to a dynamic pressure bearing surface 16a of the sleeve 316. The mirror finishing reference surface 317b is on the lower-surface side of the flange 317, which is the side opposite from the polygon mirror 318. A mirror contact surface 317c is formed on the upper-surface side of the flange 317, which is the side opposite from the mirror finishing reference surface 317b. Thus, the mirror finishing reference surface 317b is formed on the other (opposite) side of the mirror contact surface 317c from the polygon mirror 318. The exterior circumferential surface of the flange 317 projects slightly to form a guide part for press fitting (press fitting guide part) 317d (FIGS. 12 and 14) slightly above the mirror contact surface 317c. Above the mirror contact surface 317c of the flange 317, a space 317e (FIG. 12) is formed around the exterior circumferential surface of the flange 317 except the press fitting guide part 317d so as to avoid contact with the inside of the polygon mirror 318.

Two deflection reflection surfaces 318c and 318d are formed integrally with the polygon mirror 318 on its exterior circumferential surface in tiers in the axial directions. A substantially cup-like hollow is formed inside the polygon mirror 318. The polygon mirror 318 is fixed with the dynamic pressure bearing surface 316a (FIG. 12) formed on the sleeve 316 overlapping part of the deflection reflection surfaces 318c and 318d formed on the polygon mirror 318 at a position in the directions of the rotation axis. The rotary part 319 of the attraction-type magnetic bearing is fixed to the center of the ceiling part of the polygon mirror 318 by press fitting. Most of the rotary part 319 is located within the polygon mirror 318. The rotary part 319 of the attraction-type magnetic bearing has an exterior cylindrical surface. The rotary part 319 is disposed so that a magnetic gap is formed between the exterior cylindrical surface and the central circular holes of the first fixed yoke plate 309 and the second fixed yoke plate 310 as shown in FIG. 11 and that the exterior cylindrical surface is concentric with the rotation center axis. A permanent magnet or a steel-based ferromagnetic material is employed as a material for the rotary part 319 of the attraction-type magnetic bearing.

The polygon mirror 318 having a substantially cup-like hollow has its lower end open. The surface of the polygon mirror 318 at this open end opposes the upper surface of part of the flange 317 which part is formed like a step, that is, the mirror contact surface 317c. A guide part for press fitting (press fitting guide part) 318e (FIG. 12), which is an inward linear projection to oppose the press fitting guide part 317d of the flange 317, is formed circularly on the interior surface of the lower end part of the polygon mirror 318. When the polygon mirror 318 is press-fitted into the flange 317, the flange 317 and the press fitting guide part 318e of the polygon mirror 318 are fitted to each other in a minute gap. The O-ring 324, which is an elastic member, is disposed between the lower end surface of the polygon mirror 318 and the flange 317. A circular groove for receiving the O-ring 324 is formed circumferentially on the lower end surface of the polygon mirror 318. The O-ring 324 is held with its exterior surface adhering to the interior surface of the groove of the polygon mirror 318. Alternatively, the groove may be formed on the flange 317.

In order to cause the rotary body 303 to rotate at high speed, balance correction is performed at upper and lower correction surfaces 318b and 314a of the rotary body 303. A center of gravity 303a of the rotary body 303 is disposed at or around the center of the dynamic pressure bearing in the axial directions. This makes it possible to correct the balance of the rotary body 303 with high accuracy, so that it is possible to reduce unbalance vibration to an extremely low level.

Wiring patterns for electrically connecting the winding coil 312a and the Hall elements 313 to predetermined points are formed on the printed board 311. A driver circuit 320 sequentially switches current to the winding coil 312a in accordance with the position detection signals of the Hall elements 313, thereby controlling the rotary body 303 so that the rotary body 303 rotates at a constant speed.

The deflection reflection surfaces 318c and 318d of the polygon mirror 318 are integrally formed by ultraprecise cutting by the following method.

In the first process, the sleeve 316 and the flange 317 are fixed by shrink fitting.

In the second process, the interior surface of the sleeve 316 to serve as the dynamic pressure bearing surface 316a is finished with high accuracy.

In the third process, the mirror finishing reference surface 317b used in forming the deflection reflection surfaces 318c and 18d of the polygon mirror 318 is formed on the flange 317. As shown in FIG. 14, a processing jig (tapered rod) 322 is passed through the bore of the sleeve 316, so that the sleeve 316 is fixed. Cutting with a processing blade 323 is performed so that the mirror finishing reference surface 317b, perpendicular with high accuracy to the center axis of the bore of the sleeve 316, that is, the center axis of the dynamic pressure bearing, is formed on the flange 317.

In the fourth process, the polygon mirror 318 is press-fitted onto the flange 317.

The polygon mirror 318 is press-fitted onto the flange 317 with the press fitting guide parts 317d and 318e to be fitted to each other in a minute gap serving as guides, thereby preventing the center axes of the flange 317 and the polygon mirror 318 from being misaligned. The press fitting parts 317a and 318a of the flange 317 and the polygon mirror 318, respectively, pass over a fine step to be press-fitted to each other. When the press fitting is completed, the steps formed on the press fitting parts 317a and 318a of the flange 317 and the polygon mirror 318 engage each other as shown in FIG. 13. Further, when the press fitting is completed, the O-ring 324 between the lower end surface of the polygon mirror 318 and the flange 317 elastically deforms in the axial directions, so that the flange 317 and the polygon mirror 318 are fixed with the O-ring 324 being compressed with its contact surfaces (the surfaces contacting the flange 317 and the polygon mirror 318) adhering to the flange 317 and the polygon mirror 318.

In the fifth process, with the flange 317 being fixed at its mirror finishing reference surface 317b, the highly accurate reflection surfaces 318c and 318d are formed at a fixed angle to the center axis of the bore of the sleeve 316 by ultraprecise cutting.

In this embodiment, the rotary body 303 includes the sleeve 316 having the dynamic pressure bearing surface 316a formed thereon, the flange 317 fixed to the sleeve 316, the polygon mirror 318 press-fitted and fixed to the flange 317, the rotor magnet 314, which is a permanent magnet for driving, and the O-ring 324 disposed between the flange 317 and the polygon mirror 318. The polygon mirror 318 has a substantially cup-like hollow, and is fixed so that the dynamic pressure bearing surface 316a of the sleeve 316 overlaps part or all of the reflection surfaces 318c and 318d of the polygon mirror 318 at a position in the directions of the rotation axis. As a result, it is possible to obtain a light deflector in which: deformation of the mirror reflection surfaces 318c and 318d due to a change in temperature is minimized; and the center of gravity 303a of the rotary body 303 is disposed in the substantial center of the dynamic pressure bearing so as to make it possible to correct the balance of the rotary body 303 with high accuracy, thereby controlling a change in the balance (unbalance) of the rotary body 303 due to temperature so that vibration is reduced.

The mirror finishing reference surface 317b perpendicular to the dynamic pressure bearing surface 316a of the sleeve 316 is formed on the flange 317. This reduces variations in the angle of the reflection surface, thus increasing the scanning position accuracy of optical scanning.

The mirror finishing reference surface 317b is formed on the other side of the mirror contact surface 317c from the polygon mirror 318. Accordingly, the mirror finishing reference surface 317b, which has highly accurate perpendicularity to the rotation center axis of the dynamic pressure bearing, can be on the outer side of the rotary body 303 with the sleeve 316, the flange 317, and the mirror 318 being integrated. By using the mirror finishing reference surface 317b in performing mirror finishing of the reflection surfaces 318c and 318d, the mirror finishing can be performed with high accuracy.

The flange 317 and the mirror 318 are press-fitted and fixed with the press fitting inside diameter part 317a formed on the flange 317 and the press fitting outside diameter part 318a formed on the polygon mirror 318 being press-fitted and fixed. That is, the press fitting fixation part of the flange 317 and the mirror 318 is a press fitting part where the press fitting inside diameter part 317a formed on the flange 317 and the press fitting outside diameter part 318a formed on the polygon mirror 318 are press-fitted and fixed. This makes it difficult for stress due to the press fitting and fixation of the flange 317 and the mirror 318 to be transmitted to the reflection surfaces 318c and 318d of the polygon mirror 318, thereby minimizing the deformation of the reflection surfaces 318c and 318d. The press fitting part (press fitting parts 17a and 18a) is greater in diameter than the dynamic pressure bearing. Accordingly, it is possible to form the mirror finishing reference surface 317b having highly accurate perpendicularity to the rotation center axis of the dynamic pressure bearing.

The rotor magnet 314, which is a permanent magnet for driving, is fixed to the flange 317. This minimizes the deformation of the reflection surfaces 318c and 318d due to fixation of the rotor magnet 314. Since the sleeve 316 is formed of ceramic, it is possible to increase the wear resistance of the dynamic pressure bearing surface 316a, thus making it possible to prolong its useful service life. The sleeve 316 and the flange 317 are fixed by shrink fitting. This prevents the joining of the sleeve 316 and the flange 317 having different coefficients of liner expansion from being loosened by a change in temperature. Thus, the sleeve 316 and the flange 317 are firmly fixed, so that a change in vibration is reduced. The rotary part 319 of the magnetic bearing is concentrically fixed to the center part of the polygon mirror 318. This reduces variations in the vertical positions of the reflection surfaces 318c and 318d, thus increasing their positional accuracy. The reflection surface 318c and 318d are formed on the polygon mirror 318 in multiple tiers in the axial directions. This enables scanning with multiple beams from multiple light sources. The reflection surfaces 318c and 318d are formed on the mirror 318 by mirror finishing after integrating the sleeve 316 and the flange 317 with the polygon mirror 318. Accordingly, it is possible to form the highly accurate reflection surfaces 318c and 318d having a constant angle to the center axis (rotation center axis) of the dynamic pressure bearing surface 316a of the sleeve 316.

The press fitting guide parts 317d and 318e are formed on the flange 317 and the polygon mirror 318, respectively. This prevents an increase in initial unbalance due to misalignment of the center axes of the flange 317 and the polygon mirror 318 at the time of press-fitting the polygon mirror 318 to the flange 317. The press fitting guide part (outside diameter part for guiding) 317d and the press fitting guide part (inside diameter part for guiding) 318e are configured to be fitted to each other in a minute gap. Accordingly, the press fitting guide parts 317d and 318e can be formed easily. When the polygon mirror 318 is press-fitted and fixed to the flange 317, the press fitting guide part 317d of the flange 317 is positioned on the press fitting start side compared with the press fitting guide part 318e of the polygon mirror 318. Accordingly, it is possible to reduce the contact portion of the press fitting guide parts 317d and 318e of the flange 317 and the polygon mirror 318 after press fitting, thereby minimizing the deformation of the reflection surfaces 318c and 318d of the polygon mirror 318.

A coming-off prevention part is provided to the press fitting parts 317a and 318a of the flange 317 and the polygon mirror 318. As a result, the press fitting parts 317a and 318a of the flange 317 and the polygon mirror 318 are prevented from being disengaged from each other and coming off while an elastic force in the axial directions works on the flange 317 and the polygon mirror 318 so as to keep the flange 317 and the polygon mirror 318 adhering to each other. The coming-off prevention part is formed by a minute step provided on each of the press fitting part 317a of the flange 317 and the press fitting part 318a of the mirror 318. Accordingly, it is possible to form the coming-off prevention part with ease.

The space 317e overlapping at least the reflection surfaces 318c and 318d of the polygon mirror 318 at a position in the directions of the rotation axis is formed between the flange 317 and the polygon mirror 318. This prevents deformation of the reflection surfaces 318c and 318d of the polygon mirror 318 due to a change in temperature caused by the contact of the exterior surface of the flange 317 and the interior surface of the mirror 318.

The polygon mirror 318 and the flange 317 are fixed with the O-ring 324 between the lower end surface of the polygon mirror 318 and the flange 317 elastically deformed in the axial directions. Accordingly, the polygon mirror 318 is elastically fixed, so that displacement of the polygon mirror 318 due to a change in temperature or vibratory impact is prevented. This reduces a change over time in the contact with the flange 317, thus reducing a change over time in the accuracy of the deflection reflection surfaces 318c and 318d. Further, since the O-ring 324, which is an elastic member, is interposed between the flange 317 and the polygon mirror 318, a decrease in the accuracy of the reflection surfaces 318c and 318d of the polygon mirror 318 due to unevenness of the contact surfaces of the flange 317 and the polygon mirror 318 is prevented.

Further, the O-ring 324 is in contact with the flange 317 and the polygon mirror 318 with the contact surfaces of the O-ring 324 adhering thereto, thereby fixing the flange 317 and the polygon mirror 318. This makes it possible to provide a light deflector with increased sealing against entry of process oil at the time of mirror processing or entry of cleaning liquid at the time of cleaning. The O-ring 324 is held with its exterior surface adhering to the interior surface of the groove of the polygon mirror 318. This prevents deformation of the O-ring 324 due to centrifugal force when the rotary body 303 rotates after assembly, thus preventing the balance of the rotary body 303 corrected with high accuracy from being disturbed.

### Eighth Embodiment

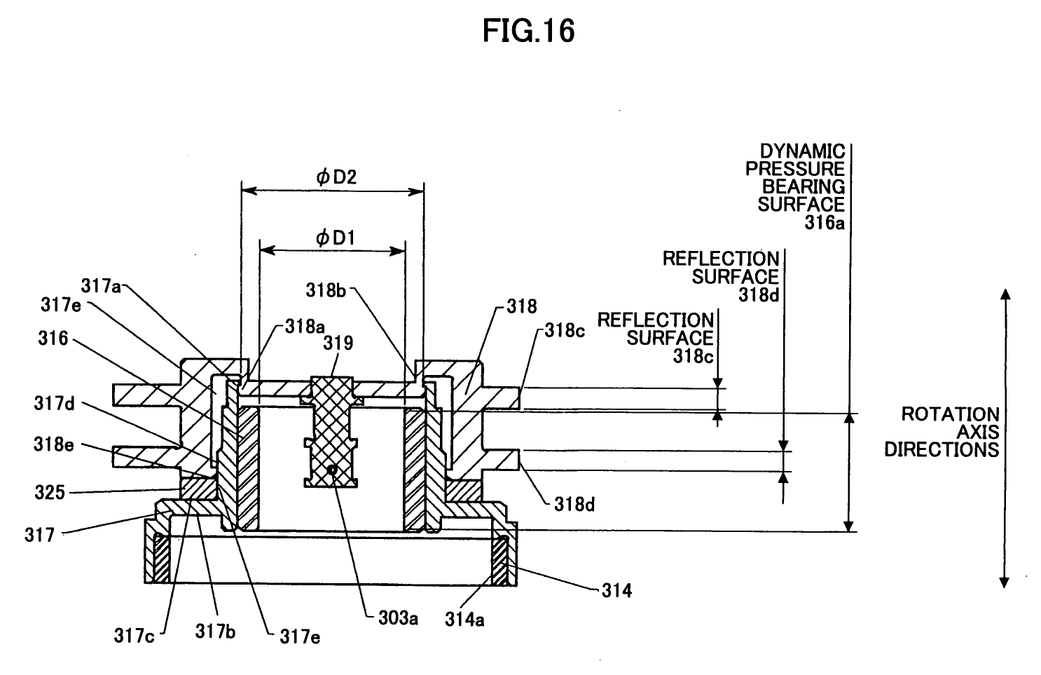

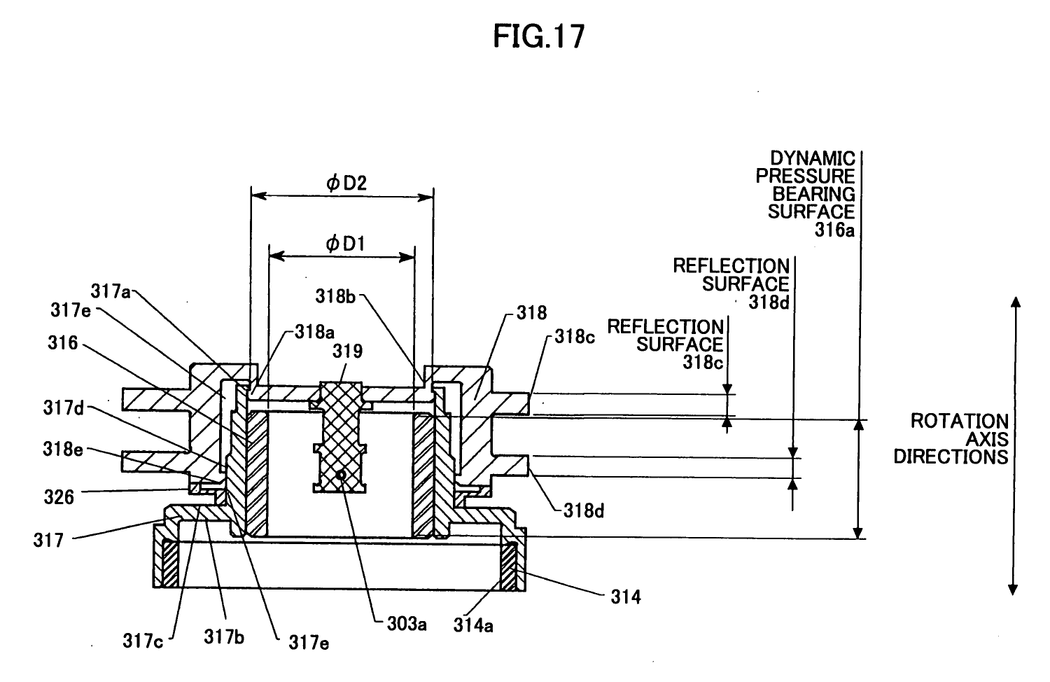

A description is given, with reference to FIGS. 16 and 17, of configurations and operations of a light deflector using a dynamic pressure air bearing according to an eighth embodiment of the present invention. The light deflector of the eighth embodiment is different from that of the seventh embodiment in the configuration of a rotary body. In the eighth embodiment, the same elements as those of the seventh embodiment are referred to by the same numerals, and a description thereof is omitted.

Referring to FIG. 16, the rotary body 303 includes the sleeve 316, the flange 317 fixed to the outside of the sleeve 316, the polygon mirror 318 fixed to the flange 317, the rotary part 319 of the magnetic bearing fixed to the polygon mirror 318, the rotor magnet 314 fixed to the flange 317, and an annular spacer 325 placed between the flange 317 and the polygon mirror 318. The annular spacer 325 is an elastic member. The flange 317 and the polygon mirror 318 are fixed with the annular spacer 325, which is an elastic member, being deformed. Accordingly, suitably, the material of the annular spacer 325 has a lower Young's modulus than the material of the polygon mirror 318.

In the configuration shown in FIG. 17, the annular spacer 325 is replaced by an annular spacer 326 having a thin-walled middle part between its exterior and interior circumferential surfaces. More specifically, the annular spacer 325 of FIG. 16 has a rectangular cross section, while in the annular spacer 326 of FIG. 17, the upper side part is removed except the outside peripheral part, and the lower side part is removed except the inside edge part, so that the middle part between the exterior and interior surfaces is formed to be thin-walled. The upper surface of the outside peripheral part of the annular spacer 326 is in contact with the bottom surface of the polygon mirror 318, and the lower surface of the inside edge part is in contact with the upper surface of the horizontal step part of the flange 317. Such a configuration of the annular spacer 326 makes it possible to employ for the annular spacer 326 a material with a Young's modulus higher than or equal to that of the polygon mirror 318.

The deflection reflection surfaces 318c and 318d of the polygon mirror 318 are integrally formed by ultraprecise cutting by the following method.

In the first process, the sleeve 316 and the flange 317 are fixed by shrink fitting.

In the second process, the interior surface of the sleeve 316 to serve as the dynamic pressure bearing surface 316a is finished with high accuracy by cutting or the like.

In the third process, the mirror finishing reference surface 317b used in forming the deflection reflection surfaces 318c and 18d of the polygon mirror 318 is formed on the flange 317. As shown in FIG. 14, the processing jig (tapered rod) 322 is passed through the bore of the sleeve 316, so that the sleeve 316 is fixed. Cutting with the processing blade 323 is performed so that the mirror finishing reference surface 317b, perpendicular with high accuracy to the center axis of the bore of the sleeve 316, that is, the center axis of the dynamic pressure bearing, is formed on the flange 317.

In the fourth process, the polygon mirror 318 is press-fitted to the flange 317. At this point, the polygon mirror 318 is press-fitted to the flange 317 with the press fitting guide parts 317d and 318e to be fitted to each other in a minute gap serving as guides, thereby preventing the center axes of the flange 317 and the polygon mirror 318 from being misaligned. The press fitting parts 317a and 318a of the flange 317 and the polygon mirror 318, respectively, pass over a fine step to be press-fitted to each other. When the press fitting is completed, the steps formed on the press fitting parts 317a and 318a of the flange 317 and the polygon mirror 318 engage each other as shown in FIG. 13. Further, when the press fitting is completed, the annular spacer 325 or 326 between the lower end (bottom) surface of the polygon mirror 318 and the flange 317 elastically deforms in the axial directions, so that the flange 317 and the polygon mirror 318 are fixed with the annular spacer 325 or 326 being compressed with its contact surfaces (the surfaces contacting the flange 317 and the polygon mirror 318) adhering to the flange 317 and the polygon mirror 318.

In the fifth process, with the flange 317 being positioned with reference to its mirror finishing reference surface 317b, the highly accurate reflection surfaces 318c and 318d are formed at a fixed angle to the center axis of the bore of the sleeve 316 by ultraprecise cutting.

According to the light deflector of the eighth embodiment, the annular spacer 325 or 326 serves as an elastic member. This facilitates processing of the elastic member and reduces the cost of the light deflector. Further, formation of a thin-walled middle part between the interior and exterior surfaces of an annular spacer as in the annular spacer 326 shown in FIG. 17 makes it possible to absorb excessive stress at the time of press-fitting the flange 317 and the polygon mirror 318 by plastic deformation. Making the coefficient of linear expansion of the annular spacer 326 shown in FIG. 17 substantially the same as that of the polygon mirror 318 or the flange 317 prevents displacement of the annular spacer 326 relative to the polygon mirror 318 or the flange 317 due to a change in temperature, thus preventing the balance of the rotary body 303 corrected with high accuracy from being disturbed.

### Ninth Embodiment

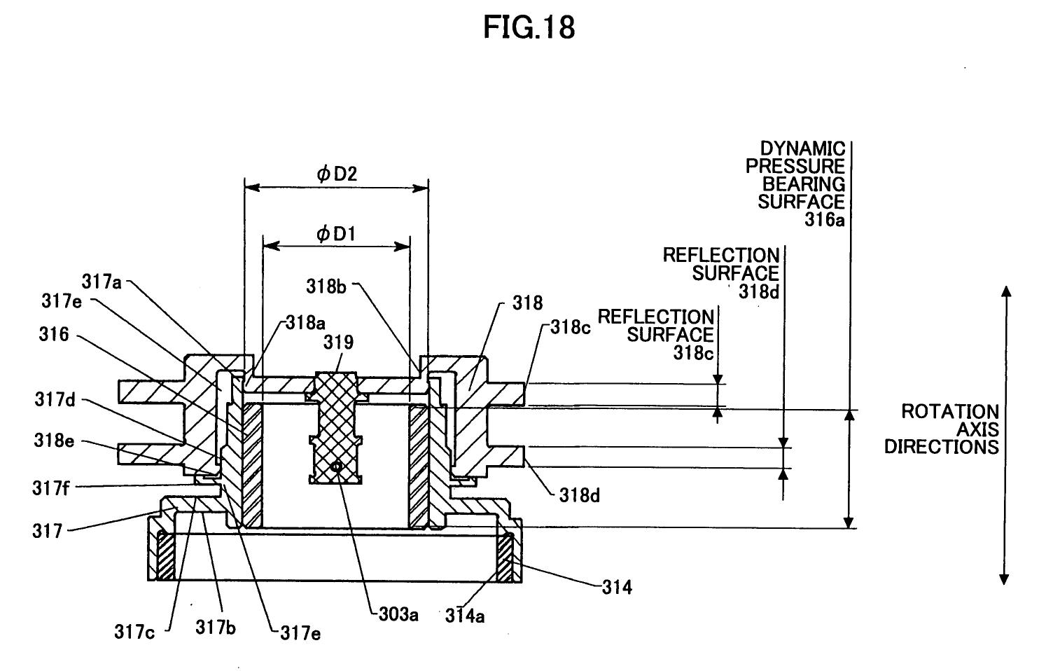

A description is given, with reference to FIG. 18, of a configuration and an operation of a light deflector using a dynamic pressure air bearing according to a ninth embodiment of the present invention. The light deflector of the ninth embodiment is different from that of the seventh embodiment in the configuration of a rotary body. In the ninth embodiment, the same elements as those of the seventh embodiment are referred to by the same numerals, and a description thereof is omitted. Referring to FIG. 18, the rotary body 303 includes the sleeve 316, the flange 317 fixed to the outside of the sleeve 316, the polygon mirror 318 fixed to the flange 317, the rotary part 319 of the magnetic bearing fixed to the polygon mirror 318, and the rotor magnet 314 fixed to the flange 317.

In the flange 317, a thin-walled connection part 317f connecting the exterior surface of the flange 317 and the mirror mounting surface of the polygon mirror 318 is formed on a part contacting the lower end surface of the polygon mirror 318. This thin-walled connection part 317f forms an elastic deformation part. The deflection reflection surfaces 318c and 318d of the polygon mirror 318 are integrally formed by ultraprecise cutting by the following method.

In the first process, the sleeve 316 and the flange 317 are fixed by shrink fitting.

In the second process, the interior surface of the sleeve 316 to serve as the dynamic pressure bearing surface 316a is finished with high accuracy.

In the third process, the mirror finishing reference surface 317b used in forming the deflection reflection surfaces 318c and 18d of the polygon mirror 318 is formed on the flange 317. As shown in FIG. 14, the processing jig (tapered rod) 322 is passed through the bore of the sleeve 316, so that the sleeve 316 is fixed. Cutting with the processing blade 323 is performed so that the mirror finishing reference surface 317b, perpendicular with high accuracy to the center axis of the bore of the sleeve 316, that is, the center axis of the dynamic pressure bearing, is formed on the flange 317.

In the fourth process, the polygon mirror 318 is press-fitted to the flange 317. At this point, the polygon mirror 318 is press-fitted to the flange 317 with the press fitting guide parts 317d and 318e to be fitted to each other in a minute gap serving as guides, thereby preventing the center axes of the flange 317 and the polygon mirror 318 from being misaligned. The press fitting parts 317a and 318a of the flange 317 and the polygon mirror 318, respectively, pass over a fine step to be press-fitted to each other. When the press fitting is completed, the steps formed on the press fitting parts 317a and 318a of the flange 317 and the polygon mirror 318 engage each other as shown in FIG. 13. Further, when the press fitting is completed, the lower end surface of the polygon mirror 318 and the connection part 317f formed on the flange 317 are fixed with the connection part 317f being elastically deformed in the axial direction.

In the fifth process, with the flange 317 being positioned with reference to its mirror finishing reference surface 317b, the highly accurate reflection surfaces 318c and 318d are formed at a fixed angle to the center axis of the bore of the sleeve 316 by ultraprecise cutting.

According to the light deflector of the ninth embodiment, the connection part 317f, which is an elastic deformation part, is formed on the flange 317. Accordingly, when the polygon mirror 318 is press-fitted to the flange 317, the polygon mirror 318 is elastically fixed, so that displacement of the polygon mirror 318 due to a change in temperature or vibratory impact is prevented. Accordingly, a change over time in the contact with the flange 317 is reduced, so that a change over time in the accuracy of the deflection reflection surfaces 318c and 318d of the polygon mirror 318 is reduced. Further, a decrease in the accuracy of the deflection reflection surfaces 318c and 318d due to unevenness of the contact surfaces of the flange 317 and the polygon mirror 318 is prevented. The above-described effects can be produced without adding a special component. Further, partial plastic deformation of the connection part 317f makes it possible to absorb excessive stress at the time of press fitting by the deformation.

### Tenth Embodiment

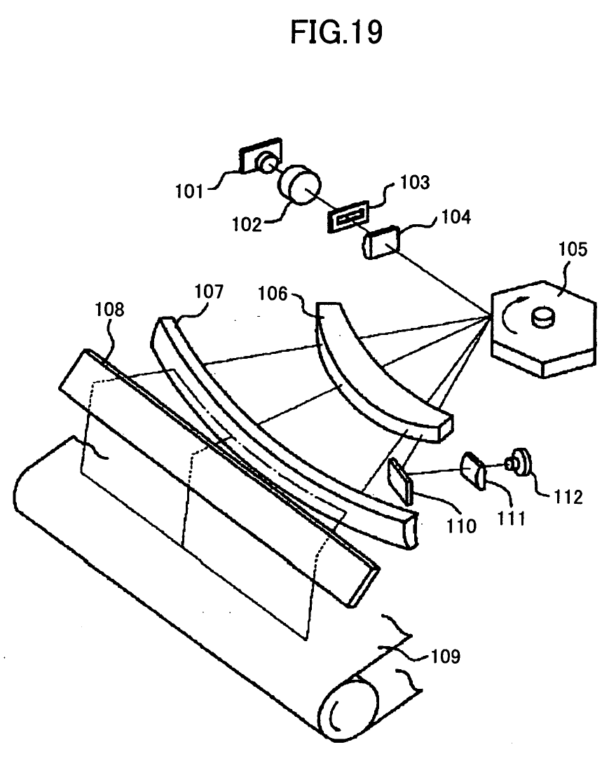

FIG. 19 is a diagram showing part of an optical scanning device according to a tenth embodiment of the present invention, which includes a light deflector according to the present invention. The optical scanning device according to this embodiment is of a single beam type.

The optical scanning device shown in FIG. 19 includes a light source 101, a coupling lens 102, an aperture 103, a cylindrical lens 104, a polygon mirror 105, lenses 106 and 107 forming a scanning optical system, a mirror 108, a photosensitive body 109, a mirror 110, a lens 111, and a light-receiving element 112.

The light source 101 is a semiconductor laser element emitting light for optical scanning. The coupling lens 102 adapts the light emitted from the light source 101 to the subsequent optical system. The aperture 103 provides the light beam for optical scanning with a predetermined shape. The cylindrical lens 104 gathers the incident light beam in the sub scanning direction. The polygon mirror 105 is a light deflector according to the present invention. The polygon mirror 105, which may correspond to the polygon mirror 318 of the above-described embodiments, is rotated by a motor to reflect the incident light on its deflection reflection surface. The lenses 106 and 107 focus the light beam on the photosensitive body 109 serving as a surface to be scanned (scanning surface). The mirror 108 bends the optical path of the light beam so as to guide the light beam to the photosensitive body 109. An electrostatic latent image is formed on the photosensitive body 109 in accordance with the light beam with which the photosensitive body 109 is illuminated. The mirror 110 and the lens 111 concentrate the light beam onto the light-receiving element 102. The light-receiving element 102 is a photodetector element such as a photodiode.

The beam emitted from the light source 101, which is a semiconductor laser element, is a divergent pencil of rays, and is coupled to the subsequent optical system by the coupling lens 102. The form of the coupled beam corresponds to the optical characteristics of the subsequent optical system. The beam may be a slightly divergent pencil of rays, a slightly convergent pencil of rays, or a parallel pencil of rays. When the beam passing through the coupling lens 102 passes through the opening of the aperture 103, the beam is subjected to “beam shaping” with the opening blocking the peripheral part of the beam where light intensity is low. Thereafter, the beam enters the cylindrical lens 104, which is a “linear imaging optical system.” The cylindrical lens 104 has a substantially half tube shape. The cylindrical lens 104 has a powerless direction (a direction in which light is not refracted) in the main scanning direction, and has positive power (power to converge light) in the sub scanning direction. The cylindrical lens 104 converges the incident beam in the sub scanning direction, and concentrates the beam on and around the deflection reflection surface of the polygon mirror 105 serving as a “light deflector.”

While being deflected in a constant angular velocity manner with the rotation of the polygon mirror 105 at a constant velocity, the beam reflected from the deflection reflection surface of the polygon mirror 105 passes through the two lenses 106 and 107 forming a “scanning optical system,” and has its optical path bent by the bending mirror 108 so as to be focused into a light spot on the photoconductive photosensitive body 109 forming the substance of the “scanning surface” and scan the scanning surface. The beam enters the mirror 110 before scanning the scanning surface, and is gathered onto the light-receiving element 112 by the lens 111. The timing of writing onto the photosensitive body 109 is determined by a control part (not graphically illustrated) based on the output of the light-receiving element 112.

Thus, a light deflector according to the present invention is applicable to an optical scanning device of a single beam type. In the optical scanning device of a single beam type to which the light deflector according to the present invention is applied, noise resulting from the vibration of the light deflector is reduced, and the deflection reflection surface of the polygon mirror 105 serving as the light deflector is maintained with high accuracy. As a result, the shape of a scanning beam is constant, thus making it possible to perform optical scanning with stability.

### 11^{th} Embodiment

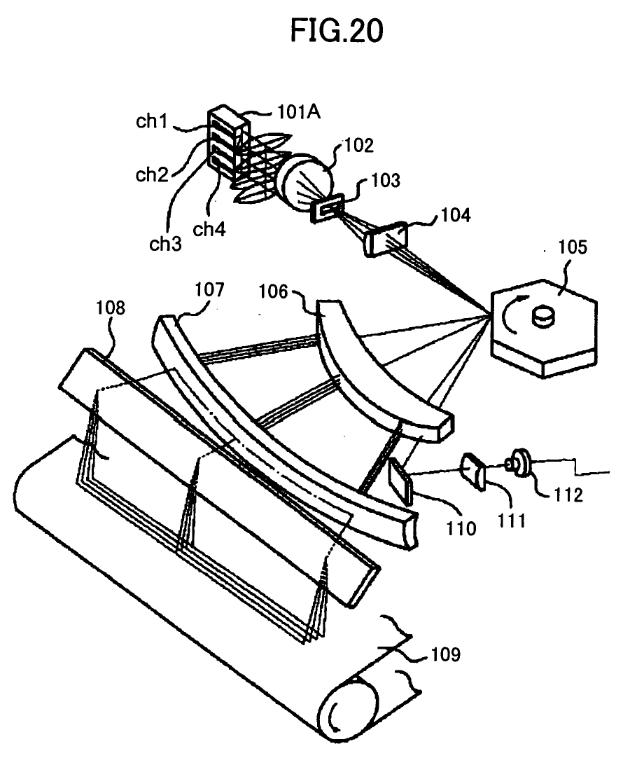

FIG. 20 is a diagram showing part of an optical scanning device according to an 11^{th} embodiment of the present invention, which includes a light deflector according to the present invention. The optical scanning device according to this embodiment is of a multi-beam type. In FIG. 20, the same elements as those of FIG. 19 are referred to by the same numerals. In the configuration of FIG. 20, a light source 101A is a semiconductor laser array in which four light emission sources ch1 through ch4 are arranged at equal intervals in an array. In this embodiment, the light emission sources ch1 through ch4 are arranged in the sub scanning direction. Alternatively, the semiconductor laser array 101A may be inclined so that the direction of the light emission source array is inclined to the main scanning direction.

Referring to FIG. 20, each of four beams emitted from the four light emission sources ch1 through ch4, which is a divergent pencil of rays of which the long axis direction of the elliptic far field pattern is directed in the main scanning direction as shown in FIG. 20, is coupled to the subsequent optical system by the coupling lens 102 common to the four beams. The form of each coupled beam corresponds to the optical characteristics of the subsequent optical system. The beam may be a slightly divergent pencil of rays, a slightly convergent pencil of rays, or a parallel pencil of rays. Each of the four beams passing through the coupling lens 102 is subjected to “beam shaping” by the aperture 103, and is converged in the sub scanning direction by the action of the cylindrical lens 104 serving as a “common linear imaging optical system.” The four beams converged in the sub scanning direction form respective linear images having length in the main scanning direction, separated from one another in the sub scanning direction, on and around the deflection reflection surface of the polygon mirror 105 serving as a “light deflector.”

The four beams deflected in a constant angular velocity manner by the deflection reflection surface of the polygon mirror 105 pass through the two lenses 106 and 107 forming a “scanning optical system,” and have their respective optical paths bent by the bending mirror 108. The four beams having their respective optical paths bent are focused into four light spots separated in the sub scanning direction on the photosensitive body 109 forming the substance of the “scanning surface,” and simultaneously scan the scanning surface with four scanning lines. One of the four beams enters the mirror 110 and is gathered onto the light-receiving element 112 by the lens 111 before scanning the scanning surface. The timing of writing onto the photosensitive body 109 by the four beams is determined by a control part (not graphically illustrated) based on the output of the light-receiving element 112.

The “scanning optical system” according to the present invention is an optical system that focuses four beams simultaneously deflected by a light deflector (the polygon mirror 105) into four light spots on the scanning surface of the photosensitive body 109, and is configured by the two lenses 106 and 107.

Thus, a light deflector according to the present invention is applicable to an optical scanning device of a multi-beam type. In the optical scanning device of a multi-beam type to which the light deflector according to the present invention is applied, noise resulting from the vibration of the light deflector is reduced, and the deflection reflection surface of the polygon mirror 105 serving as the light deflector is maintained with high accuracy. As a result, the shape of a scanning beam is constant, thus making it possible to perform optical scanning with stability.

### 12^{th} Embodiment

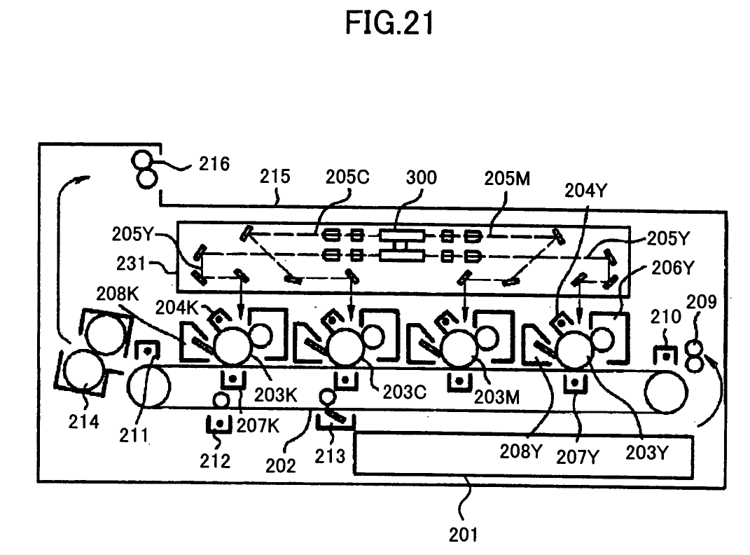

FIG. 21 is a schematic diagram showing a tandem full-color laser printer according to a 12^{th} embodiment of the present invention as an image-forming apparatus including a light deflector according to the present invention. Referring to FIG. 21, a conveyor belt 202, which is disposed horizontally to convey transfer paper (not graphically illustrated) fed from a paper feed cassette 201, is provided in the lower part of the laser printer (image-forming apparatus). A photosensitive body 203Y for yellow (Y), a photosensitive body 203M for magenta (M), a photosensitive body 203C for cyan (C), and a photosensitive body 203K for black (K) are disposed at equal intervals in order described from the upstream side above the conveyor belt 202. In the following, the additional letters Y, M, C, and K are added appropriately to reference numerals in order to distinguish between the corresponding colors.

These photosensitive bodies 203Y, 203M, 203C, and 203K are formed to have the same diameter. Process members are disposed in order around each of the photosensitive bodies 203Y, 203M, 203C, and 203K in accordance with the process of electrophotography. Taking the photosensitive body 203Y as an example, a charger 204Y, an optical scanning device 205Y, a development unit 206Y, a transfer charger 207Y, a cleaning unit 208Y, etc., are disposed in this order in the rotational direction of the photosensitive body 203Y. This is the same with the other photosensitive bodies 203M, 203C, and 203K. That is, according to this embodiment, each of the photosensitive bodies 203Y, 203M, 203C, and 203K serves as a surface to be illuminated (illumination surface) set for the corresponding color. The optical scanning devices 205Y, 205M, 205C, and 205K are provided for the photosensitive bodies 203Y, 203M, 203C, and 203K, respectively, with a one-to-one correspondence. The optical scanning devices 205Y, 205M, 205C, and 205K are integrated into an optical scanning device 231.

Further, registration rollers 209 and a belt charger 210 are provided around the conveyor belt 202 so as to be positioned on the upstream side of the photosensitive body 203Y in the direction in which the transfer paper is conveyed (paper conveyance direction). Further, a belt separation charger 211, a discharging charger 212, a cleaning unit 213, etc., are provided in order around the conveyor belt 202 so as to be positioned on the downstream side of the photosensitive body 203K. A fusing unit 214 is provided on the downstream side of the belt separation charger 211 in the paper conveyance direction. The fusing unit 214 is connected to a paper output tray 215 through paper ejection rollers 216.

In the above-described configuration, for instance, at the time of a full-color (multicolor) mode, the optical scanning devices 205Y, 205M, 205C, and 205K perform optical scanning with respective light beams so as to form respective electrostatic latent images on the corresponding photosensitive bodies 203Y, 203M, 203C, and 203K based on respective image signals for the colors of Y, M, C, and K. These electrostatic latent images are developed into toner images with toners of the corresponding colors, and are successively transferred onto the transfer paper so as to be superposed on one another. The transfer paper is conveyed, being electrostatically attracted and adhered to the conveyor belt 202. The toner images of the respective colors superposed on one another on the transfer paper are fixed onto the transfer paper as a full-color image by the fusing unit 214. The transfer paper on which the full-color image is fixed is ejected onto the paper output tray 215 by the paper ejection rollers 216.

At the time of a black-color mode (monochrome mode), the photosensitive bodies 203Y, 203M, and 203C and their respective process members are made inactive, and the optical scanning device 205K performs optical scanning with a light beam based on an image signal for black color so that an electrostatic latent image is formed only on the photosensitive body 203K. This electrostatic latent image is developed into a toner image with black toner, and is transferred onto the transfer paper electrostatically attracted and adhered to the conveyor belt 202 and conveyed thereon. The toner image transferred onto the transfer paper is fixed onto the transfer paper as a monochrome image by the fusing unit 214. The transfer paper on which the monochrome image is fixed is ejected onto the paper output tray 215 by the paper ejection rollers 216.

Thus, an optical scanning device according to the present invention is applicable to a tandem full-color laser printer. In the tandem full-color laser printer of this embodiment, to which a light deflector according to the present invention is applied, a light deflector 300 having two mirrors formed in tiers in axial directions thereon is shared by the optical scanning devices 205Y, 205M, 205C, and 205K, noise resulting from the vibration of the light deflector 300 is reduced, and the reflection surfaces of the light deflector 300 are maintained with high accuracy. As a result, the shape of a scanning beam is constant, thus making it possible to perform optical scanning with stability.

According to one embodiment of the present invention, in a light deflector, when a polygon mirror is press-fitted to a flange, the polygon mirror is elastically fixed to the flange through an elastic member provided between the polygon mirror and the flange. This prevents displacement of the polygon mirror due to a change in temperature or vibrator impact. Accordingly, a change over time in the contact with the flange is reduced, so that a change over time in the accuracy of the deflection reflection surface of the polygon mirror is reduced. Further, a decrease in the accuracy of the deflection reflection surface of the polygon mirror due to unevenness of the contact surfaces of the flange and the polygon mirror is prevented. Thus, a light deflector that can withstand high-speed rotation is provided.

According to one embodiment of the present invention, the above-described effects may also be produced without adding a special component to the light deflector.

The present invention is not limited to the specifically disclosed embodiments, and variations and modifications may be made without departing from the scope of the present invention.

The present application is based on Japanese Priority Patent Applications No. 2004-261591, filed on Sep. 8, 2004, and No. 2004-299239, filed on Oct. 13, 2004, the entire contents of which are hereby incorporated by reference.

What is claimed is:

1. A light deflector, comprising:
a rotary body supported by a dynamic pressure bearing and rotated by a motor, the rotary body including:
a sleeve having a dynamic pressure bearing surface formed on an interior circumferential surface thereof;
a flange fixed to an exterior circumferential surface of the sleeve;
a polygon mirror press-fitted and fixed to the flange; and
a permanent magnet for driving,
wherein a substantially cup-like hollow is formed inside the polygon mirror; and
the polygon mirror is fixed to the flange with the pressure bearing surface formed on the sleeve overlapping at least part of a reflection surface formed on the polygon mirror at a position in a direction of a rotation axis.

2. The light deflector as claimed in claim 1, wherein a reference surface for mirror finishing perpendicular to the dynamic pressure bearing surface of the sleeve is formed on the flange.

3. The light deflector as claimed in claim 2, wherein the reference surface for mirror finishing is formed on an opposite side of a mirror contact surface formed on the flange from the polygon mirror.

4. The light deflector as claimed in claim 1, wherein a press fitting fixation part of the flange and the polygon mirror is a press fitting part where a press fitting inside diameter part formed on the flange and a press fitting outside diameter part formed on the polygon mirror are press-fitted and fixed.

5. The light deflector as claimed in claim 4, wherein the press fitting part is greater in diameter than the dynamic pressure bearing.

6. The light deflector as claimed in claim 1, wherein the permanent magnet for driving is fixed to the flange.

7. The light deflector as claimed in claim 1, wherein the sleeve comprises ceramic.

8. The light deflector as claimed in claim 1, wherein the sleeve and the flange are fixed by shrink fitting.

9. The light deflector as claimed in claim 1, wherein a rotary part of a magnetic bearing is fixed to the polygon mirror.

10. The light deflector as claimed in claim 1, wherein the reflection surface of the polygon mirror comprises a plurality of reflection surface parts formed thereon in tiers in an axial direction.

11. The light deflector as claimed in claim 1, wherein a guide part for press fitting is formed on the flange and the polygon mirror.

12. The light deflector as claimed in claim 11, wherein the guide part for press fitting comprises an outside diameter part for guiding formed on the flange and an inside diameter part for guiding formed on the polygon mirror, the outside diameter part for guiding and the inside diameter part for guiding being fitted to each other in a minute gap.

13. The light deflector as claimed in claim 12, wherein the outside diameter part for guiding of the flange is positioned on a press fitting start side compared with the inside diameter part for guiding of the polygon mirror when the polygon mirror is press-fitted and fixed to the flange.

14. The light deflector as claimed in claim 1, wherein the polygon mirror comprises an elastic deformation part elastically deformable in an axial direction with ease.

15. The light deflector as claimed in claim 14, wherein the elastic deformation part comprises a thin-walled connection part connecting a press fitting outside diameter part and the reflection surface of the polygon mirror.

16. The light deflector as claimed in claim 1, wherein a press fitting fixation part of the flange and the polygon mirror comprises a coming-off prevention part.

17. The light deflector as claimed in claim 16, wherein the coming-off prevention part comprises a minute step formed on each of the flange and the polygon mirror in the press fitting fixation part thereof.

18. The light deflector as claimed in claim 1, wherein a space is formed between the flange and the polygon mirror, the space overlapping at least the reflection surface of the polygon mirror at a position in the direction of the rotation axis.

19. A method of manufacturing a light deflector as set forth in claim 1, wherein:
the reflection surface of the polygon mirror is formed by mirror finishing after the sleeve and the flange are integrated with the polygon mirror.

20. An optical scanning device, comprising:
a semiconductor laser; and
an optical system including a light deflector as set forth in claim 1,
wherein a beam emitted from the semiconductor laser is guided through the optical system onto a scanning surface to be scanned so as to be focused into a light spot thereon, the beam being deflected by the light deflector so as to scan the scanning surface with a scanning line.

21. An optical scanning device, comprising:
a semiconductor laser; and
an optical system including a light deflector as set forth in claim 1,
wherein a plurality of beams emitted from the semiconductor laser is guided through the optical system onto a scanning surface to be scanned so as to be focused into corresponding light spots thereon, the beams being deflected by the light deflector so as to adjacently scan the scanning surface with a plurality of scanning lines.

22. An image-forming apparatus, comprising:
an optical scanning device including a semiconductor laser and an optical system including a light deflector as set forth in claim 1; and
a photosensitive body having a photosensitive surface,
wherein a beam emitted from the semiconductor laser is guided through the optical system onto the photosensitive surface so as to be focused into a light spot thereon, the beam being deflected by the light deflector so as to scan the photosensitive surface with a scanning line, thereby forming a latent image on the photosensitive surface; and
the latent image is made visible so that an image is obtained.

23. An image-forming apparatus, comprising:
an optical scanning device including a semiconductor laser and an optical system including a light deflector as set forth in claim 1; and
a photosensitive body having a photosensitive surface,
wherein a plurality of beams emitted from the semiconductor laser is guided through the optical system onto the photosensitive surface so as to be focused into corresponding light spots thereon, the beams being deflected by the light deflector so as to adjacently scan the photosensitive surface with a plurality of scanning lines, thereby forming a latent image on the photosensitive surface; and
the latent image is made visible so that an image is obtained.

24. A light deflector, comprising:
a rotary body supported by a dynamic pressure bearing and rotated by a motor, the rotary body including:
a sleeve having a dynamic pressure bearing surface thereon;
a flange fixed to the sleeve;
a polygon mirror press-fitted and coupled to the flange; and
a permanent magnet for driving,
wherein a cup-like hollow is formed inside the polygon mirror;
the polygon mirror is fixed to the flange with at least part of a reflection surface formed on the polygon mirror overlapping the pressure bearing surface formed on the sleeve at a position in a direction of a rotation axis; and
an elastic member is provided between the flange and the polygon mirror.

25. The light deflector as claimed in claim 24, wherein the elastic member is an O-ring.

26. The light deflector as claimed in claim 25, wherein one of the flange and the polygon mirror comprises a circumferential groove holding an exterior surface of the O-ring.

27. The light deflector as claimed in claim 24, wherein the elastic member is an annular spacer.

28. The light deflector as claimed in claim 27, wherein the annular spacer is formed so as to have a thin-walled middle part between interior and exterior circumferential surfaces thereof.

29. The light deflector as claimed in claim 27, wherein the annular spacer has a coefficient of linear expansion substantially equal to a coefficient of linear expansion of one of the polygon mirror and the flange.

30. An optical scanning device, comprising:
a semiconductor laser; and
an optical system including a light deflector as set forth in claim 24,
wherein a light beam emitted from the semiconductor laser is guided through the optical system onto a scanning surface to be scanned so as to be focused into a light beam spot thereon, the light beam being deflected by the light deflector so as to scan the scanning surface with the light beam spot.

31. An optical scanning device, comprising:
a semiconductor laser emitting a plurality of light beams; and
an optical system including a light deflector as set forth in claim 24,
wherein the light beams emitted from the semiconductor laser are guided through the optical system onto a scanning surface to be scanned so as to be focused into corresponding light beam spots thereon, the light beams being deflected by the light deflector so as to adjacently scan the scanning surface with the light beam spots.

32. An image-forming apparatus, comprising:
an optical scanning device including a semiconductor laser and an optical system including a light deflector as set forth in claim 24; and
a photosensitive body having a photosensitive surface,
wherein a light beam emitted from the semiconductor laser is guided through the optical system onto the photosensitive surface so as to be focused into a light beam spot thereon, the light beam being deflected by the light deflector so as to scan the photosensitive surface with the light beam spot, thereby forming a latent image on the photosensitive surface; and
the latent image is made visible so that an image is obtained.

33. An image-forming apparatus, comprising:
an optical scanning device including a semiconductor laser emitting a plurality of light beams and an optical system including a light deflector as set forth in claim 24; and
a photosensitive body having a photosensitive surface,
wherein the light beams emitted from the semiconductor laser are guided through the optical system onto the photosensitive surface so as to be focused into corresponding light beam spots thereon, the light beams being deflected by the light deflector so as to adjacently scan the photosensitive surface with the light beam spots, thereby forming a latent image on the photosensitive surface; and
the latent image is made visible so that an image is obtained.

34. A light deflector, comprising:
a rotary body supported by a dynamic pressure bearing and rotated by a motor,
the rotary body including:
a sleeve having a dynamic pressure bearing surface thereon;
a flange fixed to the sleeve;
a polygon mirror press-fitted and coupled to the flange; and
a permanent magnet for driving,
wherein a cup-like hollow is formed inside the polygon mirror;
the polygon mirror is fixed to the flange with at least part of a reflection surface formed on the polygon mirror overlapping the pressure bearing surface formed on the sleeve at a position in a direction of a rotation axis; and
the flange has an elastic deformation part formed thereon, the elastic deformation part being easily deformable in an axial direction of the flange and brought into contact with the flange by pressure.

35. The light deflector as claimed in claim 34, wherein the elastic deformation part of the flange comprises a thin-walled connection part connecting an exterior surface of the flange and a mirror mounting surface of the polygon mirror.

36. An optical scanning device, comprising:
a semiconductor laser; and
an optical system including a light deflector as set forth in claim 34,
wherein a light beam emitted from the semiconductor laser is guided through the optical system onto a scanning surface to be scanned so as to be focused into a light beam spot thereon, the light beam being deflected by the light deflector so as to scan the scanning surface with the light beam spot.

37. An optical scanning device, comprising:
a semiconductor laser emitting a plurality of light beams; and
an optical system including a light deflector as set forth in claim 34,
wherein the light beams emitted from the semiconductor laser are guided through the optical system onto a scanning surface to be scanned so as to be focused into corresponding light beam spots thereon, the light beams being deflected by the light deflector so as to adjacently scan the scanning surface with the light beam spots.

38. An image-forming apparatus, comprising:
an optical scanning device including a semiconductor laser and an optical system including a light deflector as set forth in claim 34; and
a photosensitive body having a photosensitive surface,
wherein a light beam emitted from the semiconductor laser is guided through the optical system onto the photosensitive surface so as to be focused into a light beam spot thereon, the light beam being deflected by the light deflector so as to scan the photosensitive surface with the light beam spot, thereby forming a latent image on the photosensitive surface; and
the latent image is made visible so that an image is obtained.

39. An image-forming apparatus, comprising:
an optical scanning device including a semiconductor laser emitting a plurality of light beams and an optical system including a light deflector as set forth in claim 34; and
a photosensitive body having a photosensitive surface,
wherein the light beams emitted from the semiconductor laser are guided through the optical system onto the photosensitive surface so as to be focused into corresponding light beam spots thereon, the light beams being deflected by the light deflector so as to adjacently scan the photosensitive surface with the light beam spots, thereby forming a latent image on the photosensitive surface; and
the latent image is made visible so that an image is obtained.
